(19) United States
(12) Patent Application Publication
(10) Pub. No.: US 2005/0234835 A1
(43) Pub. Date: Oct. 20, 2005

(54) Label making apparatus and method

(75) Inventors: Joseph R. Stonoha, Fairfield, CT (US); Alfred Sgambati, Farmington, CT (US)

Correspondence Address: OHLANDT, GREELEY, RUGGIERO & PERLE, LLP, ONE LANDMARK SQUARE, 10TH FLOOR, STAMFORD, CT, 06901, US

(73) Assignee: NETC, L.L.C.

(21) Appl. No.: 11/092,351

(22) Filed: Mar. 29, 2005

Related U.S. Application Data
(63) Continuation-in-part of application No. 09/676,805, filed on Sep. 29, 2000.
(60) Provisional application No. 60/557,287, filed on Mar. 29, 2004.
(60) Provisional application No. 60/157,277, filed on Oct. 1, 1999.
(60) Provisional application No. 60/178,036, filed on Jan. 24, 2000.

(51) Int. Cl. G06F 17/00

(52) U.S. Cl. 705/401

(57) ABSTRACT

A label making apparatus that includes a computer with a label program and a label meter program. The label program has a positional palette feature that permits the assignment of an attribute scheme to character positions of a multi-position label independent of the alphanumeric content of the positions. Other features include an ad hoc job that permits the formation of a plurality of unrelated labels in a single job, but yet is versatile enough to include labels that have some ordered relationship. Other features include the ability to customize the appearance and value of the bar code and an associate human readable character set. The values of an ordered sequence can be numeric, alphabetic or a combination thereof. The label meter program automatically keeps track of a user's label stock inventory.

### RELATED APPLICATIONS

This application claims the benefit of U.S. provisional application No. 60/557,287 filed on Mar. 29, 2004, the entire contents of which are hereby incorporated by reference, and is a continuation-in-part of U.S. patent application Ser. No. 09/676,805, filed on Sep. 29, 2000, which claims the benefit of U.S. provisional application No. 60/157,277, filed on Oct. 1, 1999 and of U.S. provisional application No. 60/178,036, filed on Jan. 24, 2000.

### BACKGROUND OF THE INVENTION

1. Field of the Invention

This invention relates to a label making apparatus and a method for making labels.

2. Description of the Prior Art

Label making apparatus has used computers to form labels for addresses as well as for labeling files and articles. For example, word processing programs generally include a label making utility that allows address information or other content to be printed on a selected label blank or on all label blanks of a label stock.

An example of a computer system that can make a series of labels with each label in the series being ordered in a numerical sequence is described in U.S. Pat. No. 4,939,674. This computer system makes a series of labels, in which each label has a plurality of character positions. A number is assigned to some of the positions. The digits of the numbers are color coded so that a color assigned to a specific digit is always that color in the series of labels. The numbers of the labels in the series are an ordered sequence that, for example, increments by one, two or another amount from label to label. A drawback of this computer system is that it is limited to producing a series of related labels and is not suitable for performing a job that requires different types of labels to be formed and printed. Another drawback is that the computer system does not provide a display of a label to the user before printing. A further drawback is that the computer system has limited capabilities for printing and color assignment.

### SUMMARY OF THE INVENTION

An object of the present invention is to provide a label making apparatus that has a versatility to make a plurality of labels that have either related values, unrelated values or both in a single job.

Another object of the present invention is to provide a label making apparatus with a label inventory managing capability.

Still another object of the present invention is to provide a label making apparatus with an editable helpful hint feature.

A further object of the present invention is to provide a label making apparatus with the ability to create a series of labels having values that are numeric or alphabetic or a combination thereof.

A still further object of the present invention is to provide a method that achieves the foregoing objects.

The foregoing and other objects of the present invention are achieved by a label making apparatus that forms a data set for a series of labels. In a first embodiment, the label making apparatus includes a computer configured for interactive sessions with a graphical user interface. The computer comprises a label program that forms the data set during one or more of the interactive sessions. The label program provides to the graphical user interface a user interactive label design display screen that comprises a standard helpful hint and a user selectable option to edit the standard helpful hint to form a user customized helpful hint. The label program provides the customized helpful hint for subsequent presentations of the label design display screen to the graphical user interface.

In one variation of the first embodiment of the label making apparatus of the present invention, the graphical user interface comprises a display and one or more input devices. The label design display screen is presented on the display. The user uses the one or more input devices to select the user selectable option and to edit the standard helpful hint.

In another variation of the first embodiment of the label making apparatus of the present invention, the label program uses the data set to control the printer to print the series of labels on label stock.

In a second embodiment of the label making apparatus of the present invention, the data set is formed for a series of labels that have an ordered sequence of values with each label including a machine readable code and a human readable character set. The label program provides to the graphical user interface one or more user interactive label design display screens that comprise user selectable options to select attributes for the bar code and for the human readable character set. The attributes comprise alphabetic and/or alphanumeric values. The label program incorporates attributes selected by the user into the data set so that the ordered sequence has alphabetic and/or alphanumeric values.

In one variation of the second embodiment of the label making apparatus of the present invention, the bar code attributes comprise one or more of the bar code attributes selected from the group consisting of: bar code length, bar width, wide bar ratio, inter-character space width, wide space ratio, bar code orientation, numeric value, alphanumeric value, alphabetic value and base for the values.

In another variation of the second embodiment of the label making apparatus of the present invention, the label program uses the data set to print the series of labels on a label stock.

In another variation of the second embodiment of the label making apparatus of the present invention, the label program responds to a user selection of at least one of the user selectable options to generate bar code values of a bar code and associated human readable values for the series of labels.

In another variation of the second embodiment of the label making apparatus of the present invention, at least one of the bar code values and an associated one of the human readable values differ from one another.

In another variation of the second embodiment of the label making apparatus of the present invention, the ordered sequence of at least one of the bar codes and human readable character sets is selected from the group consisting of: numeric, alphanumeric and alphabetic.

In another variation of the second embodiment of the label making apparatus of the present invention, the label program responds to a user selection of at least one of the user selectable options to establish a base in the range of 2 through 36 for the ordered sequence.

In another variation of the second embodiment of the label making apparatus of the present invention, the label program responds to a user selection of at least one of the user selectable options to establish a base in the range of 11 through 36 for the ordered sequence.

In another variation of the second embodiment of the label making apparatus of the present invention, the label program responds to a user selection of at least one of the user selectable options to exclude numeric values from the ordered sequence.

In another variation of the second embodiment of the label making apparatus of the present invention, the label program responds to a user selection of at least one of the user selectable options that inputs a bar code type to present to the user a set of user selectable bar code attributes based on the bar code type.

In another variation of the second embodiment of the label making apparatus of the present invention, the label program responds to a user selection of at least one of the user selectable options, which regards printing the series of labels on label stock, to select a skew adjustment or a fine print adjustment.

In another variation of the second embodiment of the label making apparatus of the present invention, the label program responds to a user selection of at least one of the user selectable options to select character justification in a character cell.

In another variation of the second embodiment of the label making apparatus of the present invention, the graphical user interface comprises a display and one or more input devices. The label design display screen is presented on the display. The user uses the one or more input devices to select the user selectable option and to select the user selectable options.

In another variation of the second embodiment of the label making apparatus of the present invention, at least one of the label design display screens provides to the graphical user interface one or more user selectable options to position a label indicator within a cell of either the bar code or the human readable character set of at least one label of the series of labels.

In another variation of the second embodiment of the label making apparatus of the present invention, the label indicator is positionable in a corner of at least one of the cells of the human readable character set.

In another variation of the second embodiment of the label making apparatus of the present invention, the label indicator is positionable within at least one end cell of the bar code.

In a first embodiment of the method of the present invention, a computer and a graphical user interface are used in interactive sessions for forming a data set for a series of labels. The computer is used to provide to the graphical user interface during one or more of the user interactive sessions, a user interactive label design display screen that comprises a standard helpful hint and a user selectable option to edit the standard helpful hint. In response to the user editing the standard helpful hint a user customized helpful hint is formed. Thereafter, the customized helpful hint is provided for subsequent presentations of the label design display screen to the graphical user interface.

In a second embodiment of the method of the present invention, a computer and a graphical user interface are used in interactive sessions for forming a data set for a series of labels that have an ordered sequence of values. Each label includes a machine-readable code and a human readable character set. The computer is used to provide to the graphical user interface during one or more of the user interactive sessions, at least one user interactive label design display screen. The label design display screen comprises user selectable options to select attributes for the bar code and for the human readable character set, which attributes comprise alphabetic and/or alphanumeric values. The label program incorporates attributes selected by the user into the data set so that the ordered sequence has alphabetic and/or alphanumeric values.

In the memory media embodiments of the present invention, a memory media comprises executable instructions of a label program for controlling the computer for the steps of the first and second method embodiments of the present invention.

### BRIEF DESCRIPTION OF THE DRAWINGS

Other and further objects, advantages and features of the present invention will be understood by reference to the following specification in conjunction with the accompanying drawings, in which like reference characters denote like elements of structure and:

FIG. 1 is a block diagram of a networked system that includes the label making apparatus of the present invention;

FIG. 2 is a block diagram of the label making apparatus of FIG. 1;

FIG. 3 depicts a label with a positional attribute scheme;

FIG. 4 depicts a label with a horizontal orientation;

FIG. 5 depicts a label with a suppressed bar code;

FIG. 6 is a display screen used for an ad hoc job by the label making apparatus of FIG. 1;

FIG. 7 is an expansion of the display screen of FIG. 6;

FIG. 8 is a display screen used for a serial job by the label making apparatus of FIG. 1;

FIG. 9 is a display screen used for a positional palette;

FIG. 10 is a display screen used for printing labels;

FIGS. 11 through 17 are flow diagrams of the label program of the label making apparatus of FIGS. 1 and 2;

FIG. 18 is a label meter display screen for the label meter program of the label making apparatus of FIGS. 1 and 2;

FIG. 19 is a flow diagram of the label meter program of the label making apparatus of FIGS. 1 and 2;

FIG. 20 is a display screen for helpful hints;

FIG. 21 is another view of the display screen of FIG. 20;

FIG. 22 is a display screen for setting label template barcode attributes;

FIG. 23 is display screen for setting label template human readable attributes;

FIG. 24 is a display screen for setting general attributes;

FIG. 25 is an alternate ad hoc job display screen;

FIG. 26 is a display screen for an ad hoc job for adding labels;

FIG. 27 is a display screen for bar code data of a serial job;

FIG. 28 is a display screen for human readable data of a serial job;

FIG. 29 is an alternate display screen for printer instructions;

FIGS. 30 through 35 are flow diagrams of the label program of the label making apparatus of the present invention; and

FIG. 36 is a display screen for the inventory assistant of FIG. 2.

### DETAILED DESCRIPTION OF THE INVENTION

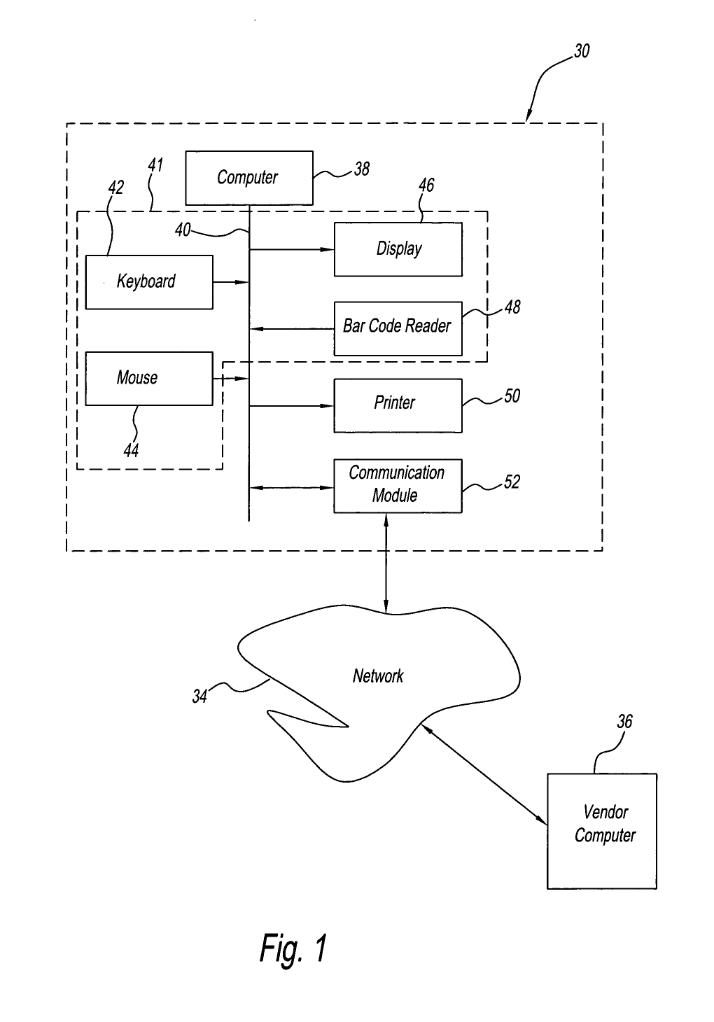

With reference to FIG. 1, there is provided a label making apparatus generally represented by numeral 30. Label making apparatus 30 communicates via a network 34 with a vendor computer 36. Vendor computer 36 may provide various services to label making apparatus 30. For example, vendor computer 36 may provide via an e-commerce procedure software sales, downloading, updating, announcements, label stock sales and the like. Network 34 may be the Internet, the World Wide Web, a telephone network, other networks or a combination thereof.

Label making apparatus 30 includes a computer 38, a computer bus 40, a graphical user interface 41, a printer 50 and a communication module 52. Computer bus 40 interconnects computer 38 with graphical user interface 41, printer 50 and communication module 52. Communication module 52 sends and receives messages via network 34 to and from vendor computer 36 or other devices. Graphical user interface 41 comprises a keyboard 44, a mouse 44, a display 46 and a bar code reader 48. Keyboard 42, mouse 44 and bar code reader 48 are input devices that can be used by a user to make entries to specify label jobs for label making apparatus 30. It will be apparent to those skilled in the art that other input devices can be used.

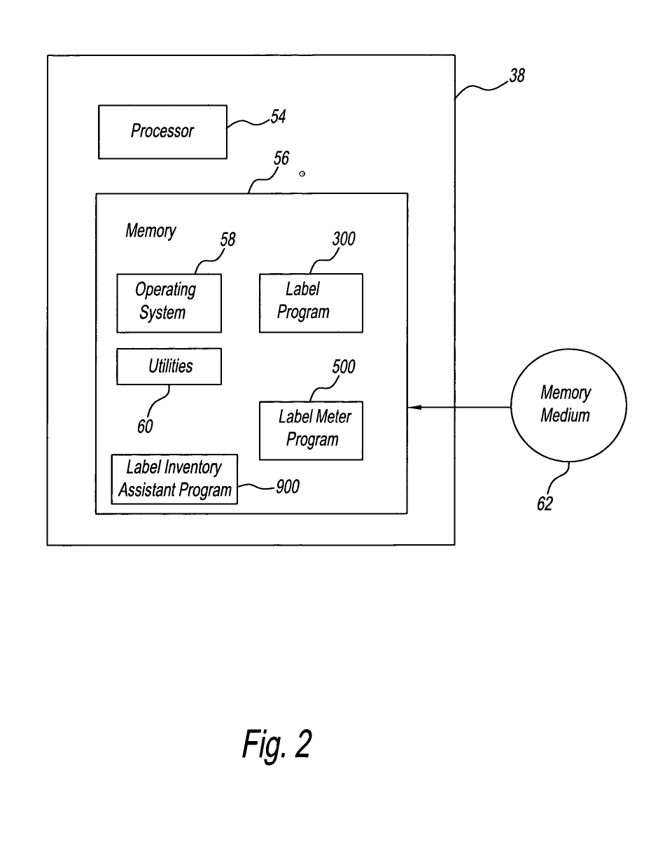

Referring to FIG. 2, computer 38 includes a processor 54 and a memory 56. Memory 56 has stored therein an operating system 58, utilities 60, a label program 300, a label meter program 500 and a label inventory assistant program 900. Operating system 58 controls processor 54 to perform various operations through the use of utilities 60. Thus, utilities 60 include print, display and other utilities. Label program 300 uses operating system 58 and utilities 60 to control label making apparatus 30 to make and print labels based on entries made by a user via graphical user interface 41. That is, label program 300 operates as a label data engine that generates a data set for the labels of a job. Label meter program 500 uses operating system 58 and utilities 60 to control label making apparatus 30 to keep track of labels used, refill labels ordered, refill labels received so as to maintain an adequate label inventory and prevent execution of printing jobs when the inventory is inadequate. Label inventory assistant program 900 can be used in place of label meter program 500 or in conjunction therewith.

Software, such as operating system 58, utilities 60, label program 300 and label meter program 500, can be installed to memory 56 from a memory medium 62. This software, which may comprise executable instructions, may be read from memory medium 62 by a memory device associated with computer 38 or by a memory device associated with another computer, such as vendor computer 36 and downloaded to computer 38 via network 34.

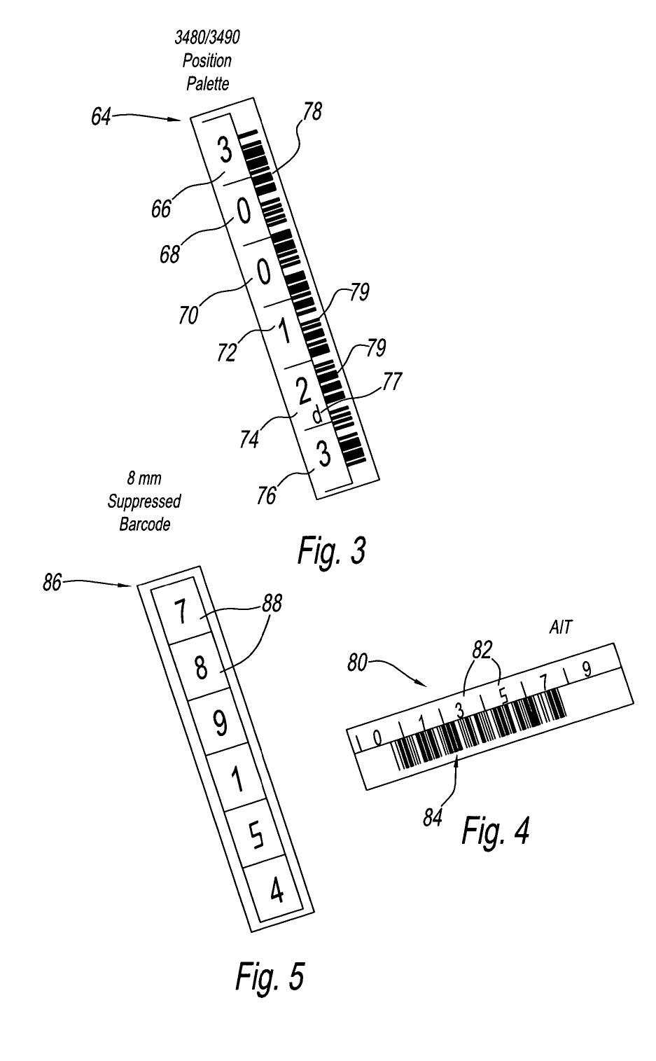

Referring to FIG. 3, a label 64 has a plurality of character positions 66, 68, 70, 72, 74 and 76 that have a vertical alignment, in which the characters are read vertically. A machine-readable code, e.g., a bar code 78, is located to the right of character positions 66, 68, 70, 72, 74 and 76. According to an aspect of the invention, a positional attribute scheme or palette is assigned to character positions 66, 68 and 70. Character positions 66, 68 and 70 each may have the same or different positional palettes. For all labels created with the positional palette, the assigned attributes of character positions 66, 68 and 70 will be the same independent of the value of any alphabetic or numeric character contained therein. Character positions 66, 68 and 70 may be, for example, a prefix. A label indicator 77, shown as “d”, is located in character position 74.

Bar code 78 has a plurality of elements 79 that are arranged for reading in a particular direction, for example, from top to bottom. According to an aspect of this invention, the reading direction may be rotated by 180° for reading from bottom to top.

Referring to FIG. 4, a label 80 has a plurality of character positions 82 aligned horizontally, in which the characters are read from left to right. A bar code 84 is located below character positions 82.

Referring to FIG. 5, a label 86 includes a plurality of character positions 88. Label 86 has no bar code. According to an aspect of this invention, generation of a bar code can be suppressed. It will be apparent to those skilled in the art that bar codes 78 and 84 are by way of example, and that other machine readable codes may be used.

A user operates label making apparatus 30 to generate a set of data that represents the indicia on the labels. The user uses graphical user interface 41 in one or more interactive sessions with computer 38 to specify the indicia by selection of user selectable options. The selection may be a simple mouse click and/or an input of data. The indicia, for example, can be alphanumeric characters, bar codes, colors, magnetically written codes or any other recordable indicia. The user also specifies the ordering of the indicia for a series of labels. The ordering for can be by color, numbering, alphabetic or other sequence. The ordering can use even or odd numbers or both or any base such as 2,or any other base suited to a particular job. In some cases the ordering may indicate a personal identification number, such as a PIN number, social security number or other identification number. The ordering may progress by increments of 1, 2, or any suitable incrementing value.

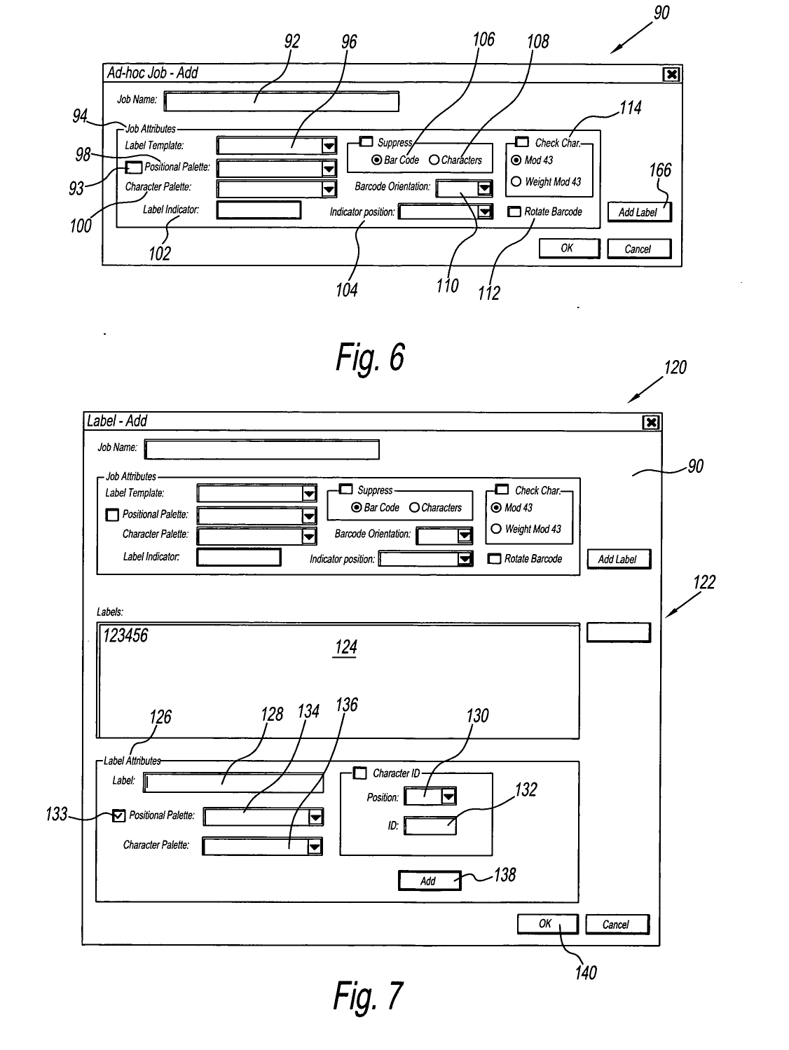

Referring to FIG. 6, a display screen 90 is presented on display 46 when a user selects an ad hoc job for creating labels. An ad hoc job includes a variety of different labels that may or may not be related, for example, by value ordering. For instance, an ad hoc job may include replacement labels for an existing set of labels. Some of these labels will bear no ordered sequential relation to other labels in the job. However, the ad hoc job is versatile enough to include a group of labels that have an ordered sequence.

Display screen 90 includes various user entry areas. The user entry areas of display screen 90 in FIG. 6 or of the display screens of the other Figures are user selectable options by which the user through operation of keyboard 42 or mouse 44 can input or edit indicia and/or attributes for a label or series of labels. A job name 92 is for entry of a name for the job. A job attributes 94 is for entry of a positional palette 98 or a character palette 100. These palettes may be selected from a repertoire of positional palettes or of character palettes.

Alternatively, these palettes may be created from another menu (not shown) that permits selection of background and/or foreground color. A label template 96 is for entry of a label template. Label template 96 describes the label stock sheet along with attributes not controlled by the user that are unique to a particular label type. An example of such an attribute is the percentage of label height occupied by a bar code. A label indicator 102 is for entry of a label indicator and an indicator position 104 is for the location of the indicator. Label indicator 102 and indicator position 104 are used to place a special character or characters in the bar code portion of the label. These special characters are not visible.

A suppress bar code 106 is for suppression of the bar code and a suppress character 108 is for suppression of the characters. A bar code orientation 110 is for identifying the location of the bar code relative to the character positions, for example, to the right or left, above or below. A rotate bar code 112 is for reversal of bar code elements. A check character 114 is for addition of a check character to the bar code. An add button is for adding labels. Labels may be added by importing or by creating. Labels may be imported from an existing data file. These labels may be from a preexisting job or may be created by reading the bar codes of a set of labels with bar code reader 48.

Referring to FIG. 7, a display screen 120 is presented if the labels are to be created. Display screen 120 includes display screen 90 and a lower portion 122. Lower portion 122 permits entry of the alphanumeric content of the labels of the job, one label at a time. To this end, a label attributes section 126 permits entry of the label content at 128 and changes in the positional palette at 134 or in the character palette at 136 that were previously selected via display screen 90. That is, the positional and character palettes selected via display screen 90 are used for all labels to be created, unless the user makes changes at 134 or 136. The alphanumeric content is entered via a character position 130 and a character ID or content 132, one character position at a time. An area 128 displays the entered content of the label. As each label is completed, actuation of an add button 138 lists it in a display area 124. When the ad hoc job is finished, an OK button 140 is actuated.

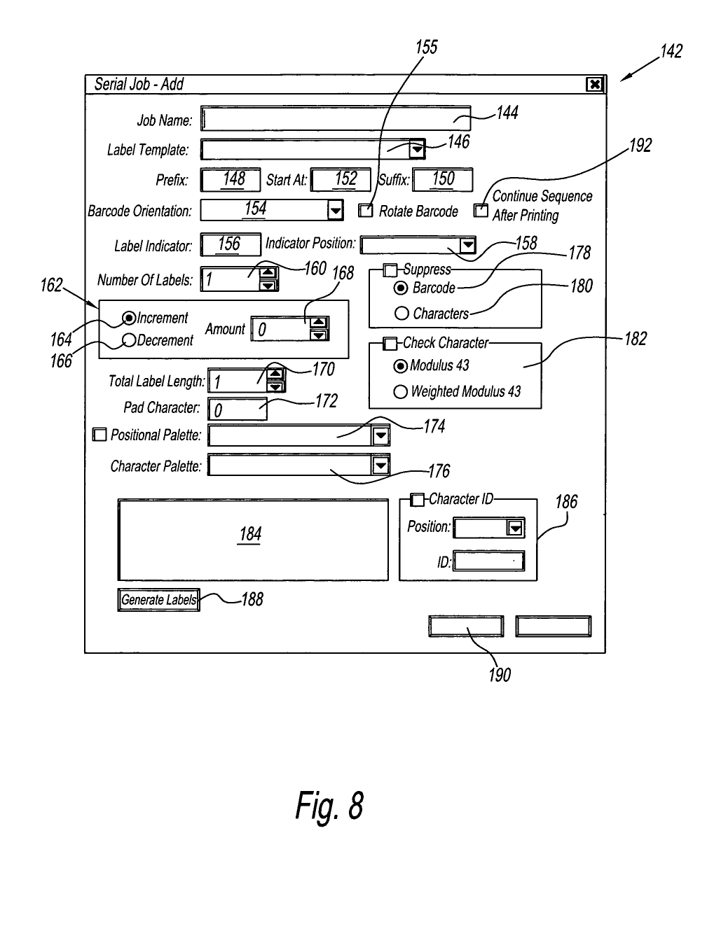

Referring to FIG. 8, if the user selects a serial job, a serial display screen 142 is presented. Serial display screen 142 includes a job name 144, a label template 146, a bar code orientation 154, a rotate bar code 155, a label indicator 156, an indicator position 158, a bar code suppress 178, a characters suppress 180, a positional palette 174 and a character palette 176. Each has the same functionality as the like named entry areas of ad hoc display screen 90 in FIGS. 6 and 7.

Serial display screen 142 further includes a prefix 148, a suffix 150, a start at 152, a check character 182 and a character ID 186. Prefix 148 and suffix 150 allow the user to identify a prefix or a suffix. Start at 152 permits identification of a starting position for the prefix or suffix. Check character 182 allows the user to designate a check character of modulus 43 or weighted modulus 43. Character ID 186 has the same functionality as character ID 132 of FIG. 7.

Serial display screen 142 also includes a number of labels 160 for entry of the number of labels in the serial sequence. A numerical sequence 162 includes an increment 164 and a decrement 166 to designate whether the sequence is ascending (increment) or descending (decrement) and an amount 168 to designate the amount of increment or decrement. For example, if increment is selected and the amount is 2, the increment is by twos. A continue sequence after printing 192 permits the user to instruct label program 300 to save a notation that when additional labels of the same series are needed in the future, they will start with the next number of the ordered sequence. The user may specify the total label length in terms of the number of characters in a box 170. A pad character 172 must be added as a filler in some labels. For example, three pad characters, “0” are added in the label A0001Z. Actuation of a generate button 188 causes label program 300 present to the content of the labels of the job in a display area 184. When the serial job entry is completed, an OK button 190 is actuated. This causes the labels of the job to be placed in a data file.

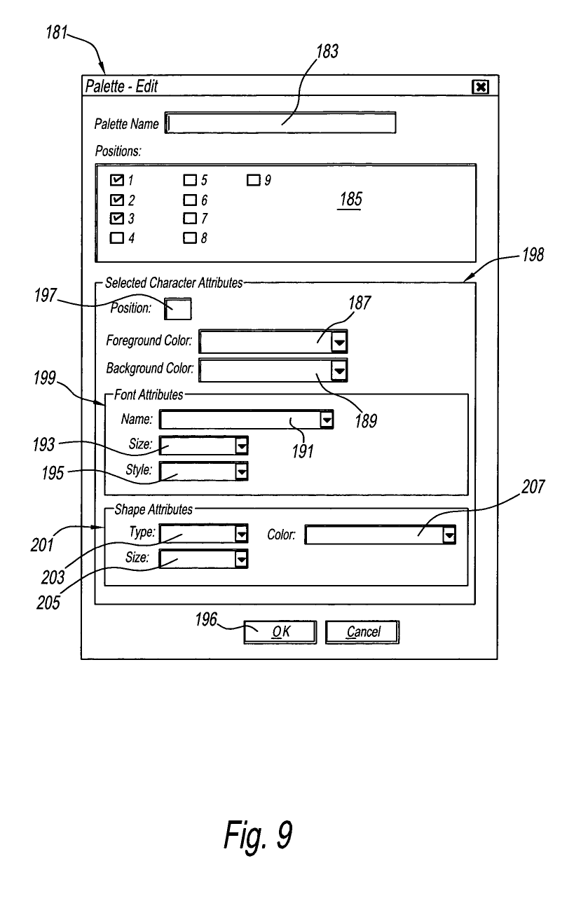

Referring to FIG. 9, a display screen 181 for the formation of a positional palette is shown. Display screen 181 includes a positional palette name area 183 for entry of the positional palette name. An attribute area 198 includes a plurality of entry areas to define the attributes of the positional palette. Attribute area 198 includes a position area 197 for identifying the current character position for which attributes are being defined. For the current character position, the foreground color is entered in a foreground color area 187 and the background color is entered in a background area 189. A font attributes area 199 includes a font name area 191 for entry of a desired font name, a font size area 193 for entry of a font size and a font style area 195 for entry of a font style, such as normal, bold, italics, underscore, and the like. A shape attributes area 201 includes a type area 203, a size area 205 and a color area 207. Shape attributes area 201 permits entry of a geometrical shape in a character position. The shape, for example, may be a circle, a triangle, a rectangle, a square or any other shape. This shape is entered in type area 203. Size area 205 is for entry of the size of the shape, for example as a percentage of the character position area. Color area 207 is for entry of the color of the shape. To identify the character positions that the entered attributes are to apply, a check is entered in the box adjacent its number in a display area 185. If there is no check mark for a position, that position can be defined by a character palette. When the positional palette has been defined, an OK button 196 is actuated.

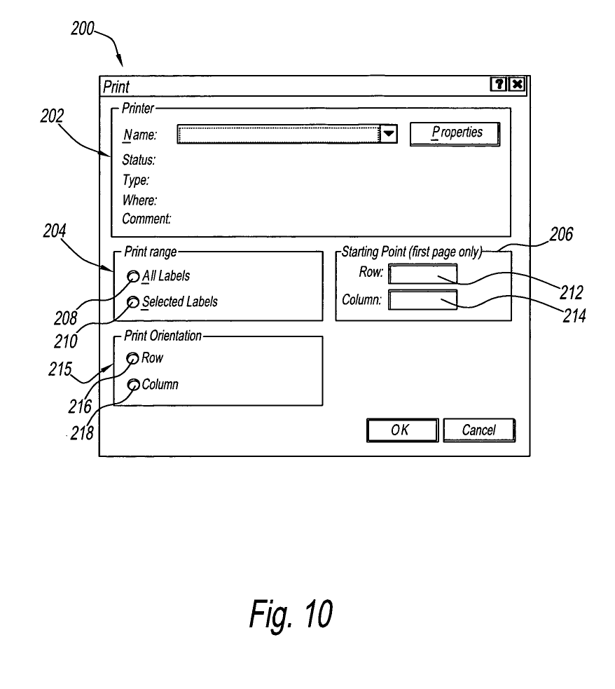

Referring to FIG. 10, a display screen 200 for printing entries is shown. Display screen 200 includes a printer definition area 202, a print range area 204, a starting point area 206 and a print orientation area 215. Print range area 204 includes an all labels area 208 and a selected labels area 210. If selected labels area 210 is selected, a drop down box or other selection technique may be used for identifying the selected labels. Starting point area 206 includes a row area 212 and a column area 214 to identify the label blank on a label stock at which printing is to begin. Print orientation area 215 includes a row area 216 and a column area 218. If row area is selected, printing proceeds serial by row of the label stock. If column area 218 is selected, printing proceeds serial by column of the label stock.

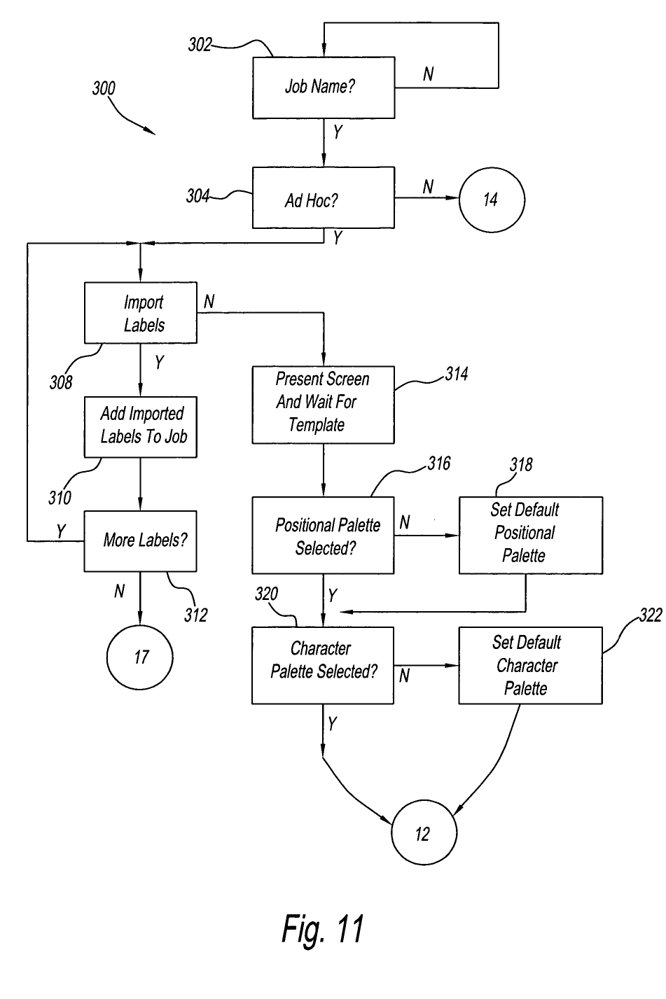

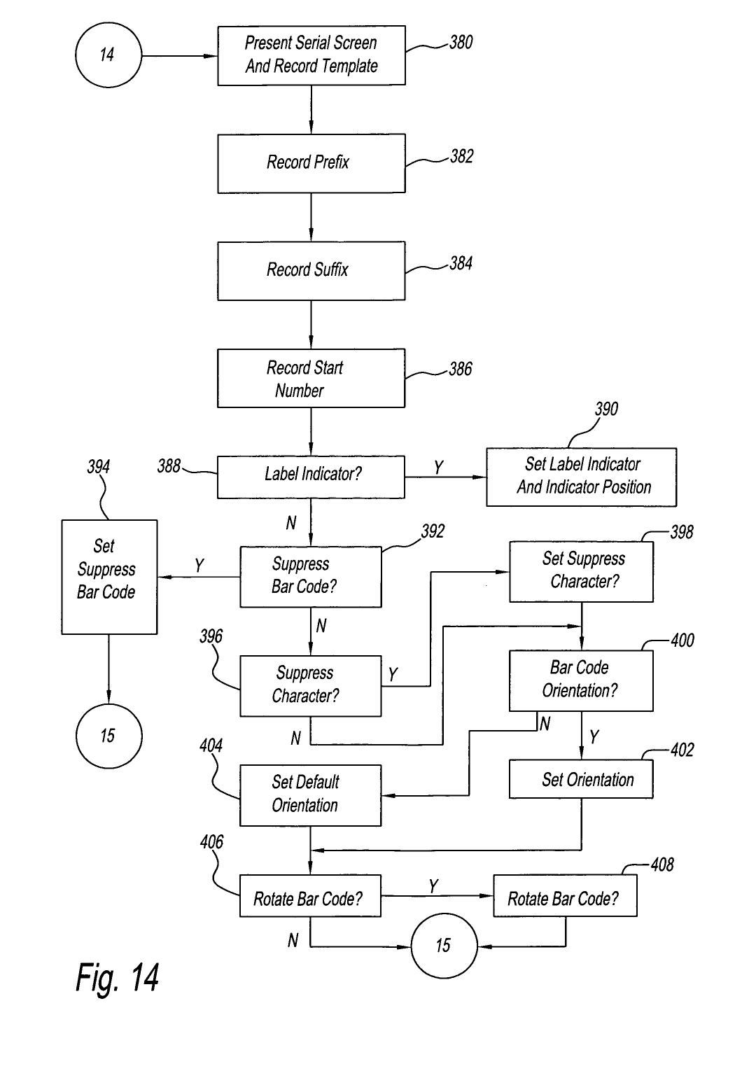

Referring to FIG. 11, label program 300 begins at step 302 with a determination of whether a job name has been entered. If not, step 302 continues until a job name is entered. When entered, step 304 determines if the job is an ad hoc job. If not, the job is serial and control passes to a point 14 that is continued in FIG. 14.

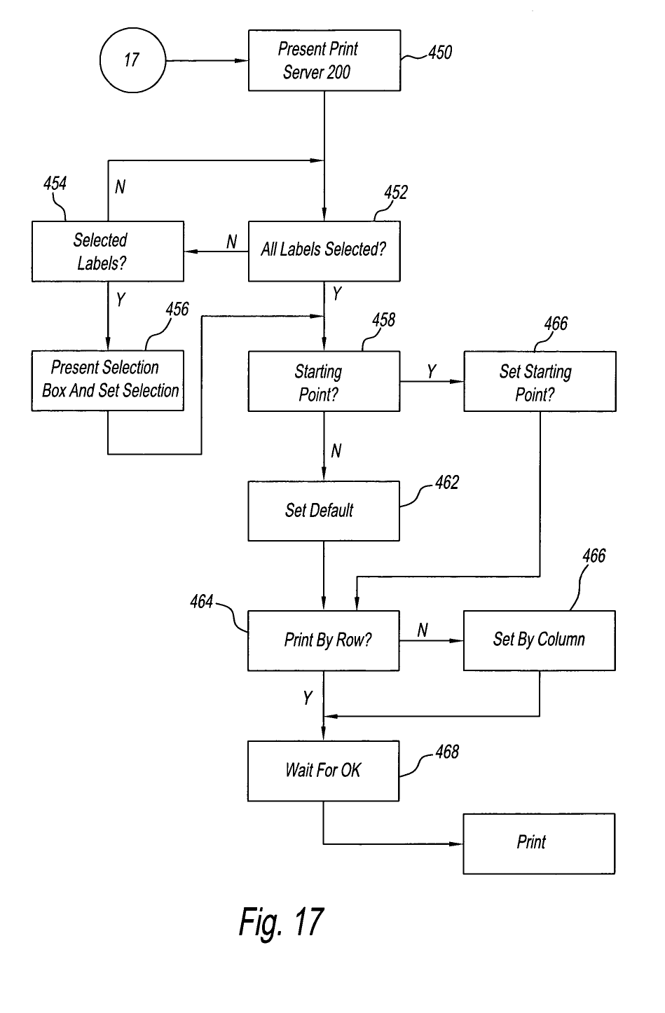

If step 304 determines that the job is an ad hoc job, step 308 determines if labels are to be imported. If yes, step 310 adds the imported labels to the job. Step 312 then determines if more labels are in the job. If not, control passes to point 17 that is continued in FIG. 17. If yes, step 308 is repeated. If step 308 determines that labels are to be imported, steps 310 and 312 are repeated. When step 308 determines that no labels are to be imported, step 314 presents ad hoc display screen 90 and waits for a label template to be selected.

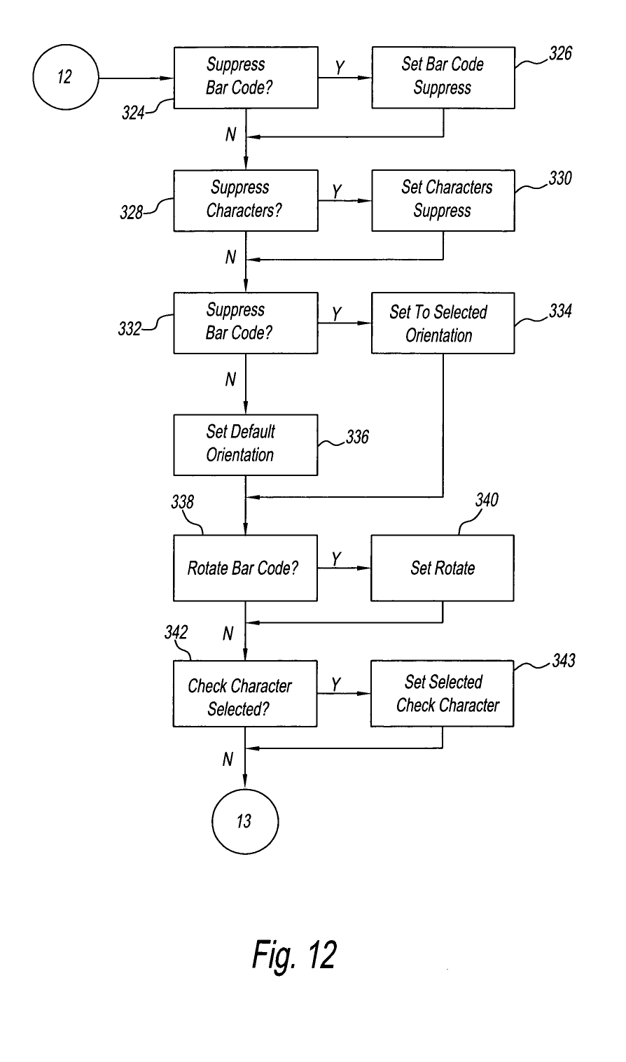

When a label template has been selected, step 316 determines if a positional palette has been selected and, if yes, sets the selected positional palette and control passes to step 320. If not, step 318 sets a default positional palette. Step 320 then determines if a character palette has been selected and, if yes, sets the selected character palette. If not, step 322 sets a default character palette. Steps 320 or 322 pass control to point 12 that is continued in FIG. 12.

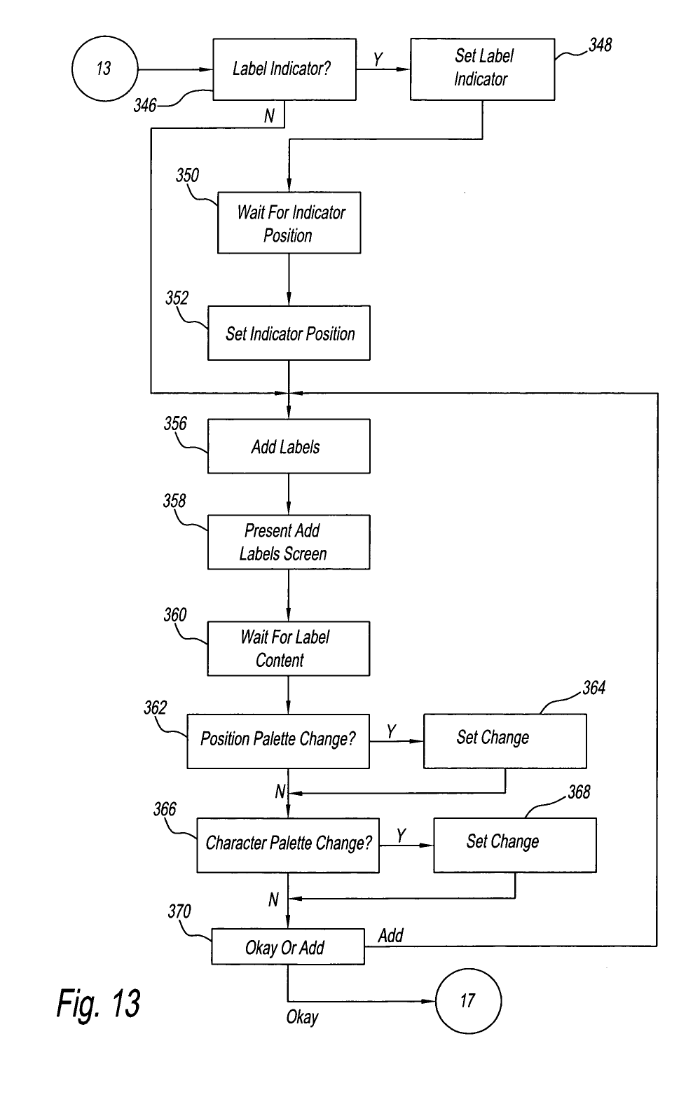

Referring to FIG. 12, point 12 continues with step 324 that determines if the bar code is to be suppressed. If yes, step 326 sets bar code suppress and control passes to step 328. If not, step 328 determines if the characters are to be suppressed. If yes, step 330 sets characters suppress and passes control to step 332. If not, step 332 determines if a bar code orientation has been entered. If yes, step 334 sets the selected orientation. If not, step 336 sets a default orientation. Step 338 then determines if the bar code is to be rotated. If so, step 340 sets rotate bar code. Step 342 in response to a determination of no by step 338 or a completion of step 340 then determines if a check character has been entered. If yes, step 343 sets the selected check character. After step 343 or if step 342 determines that a check character is not selected, control passes to point 13, which is continued in FIG. 13.

Referring to FIG. 13, point 13 continues with step 346 that determines if a label indicator has been entered. If not, control passes to step 356. If yes, step 348 sets label indicator. Step 350 then waits for entry of an indicator position. When entered the indicator position is set by step 352. Step 356 waits for actuation of add labels button 166 or add button 138. When either is actuated, step 358 presents a clear display screen 120 (FIG. 7) for the user to enter the content of the label. When the label content has been entered, step 360 waits for entry of label content.

Step 362 determines if there is a change in positional palette for this label. If yes, step 364 sets the change and control passes to step 366. If step 362 determines there is no change, step 366 determines if there is a change in character palette for this label. If yes, step 368 sets the change and control passes to step 370. If step 366 determines there is no change, step 370 determines if add button 138 or OK button 140 has been actuated (FIG. 7). If add button 138 is actuated, steps 356 through 370 are repeated. If OK button 140 is actuated, control passes to point 17, which is continued in FIG. 17.

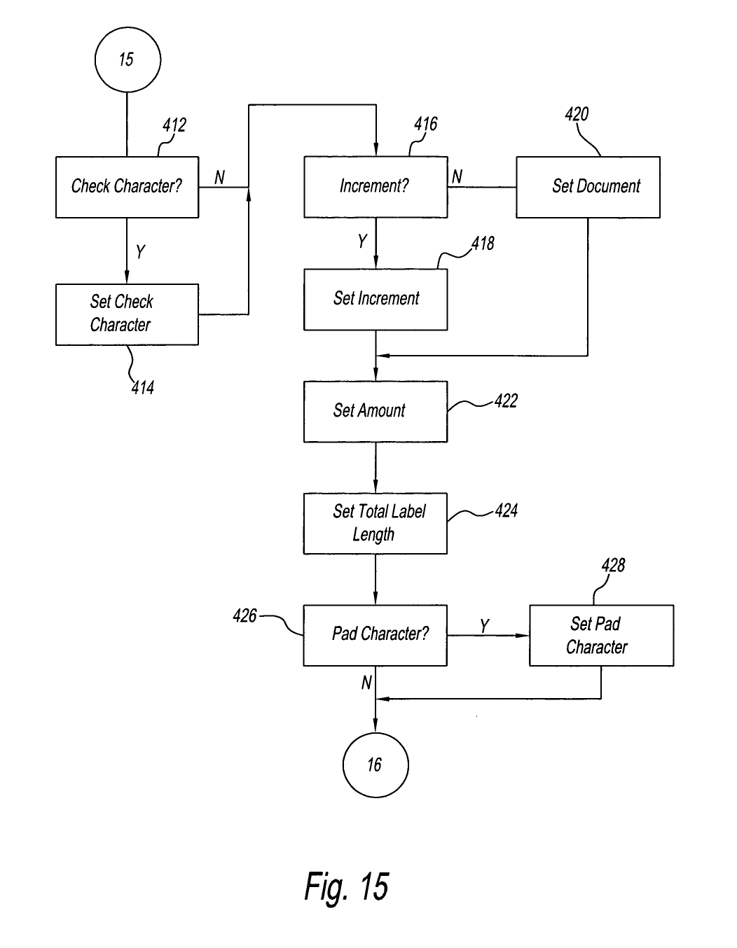

Referring to FIG. 14, point 14 continues to step 380 that presents serial screen 142 (FIG. 8) and records a template selection. Step 382 records a prefix, if selected. Step 384 records a suffix, if selected. Step 386 records the starting number for the ordered sequence. Step 388 determines if a label indicator has been entered. If not, control passes to step 392. If yes, step 390 sets label indicator and indicator position. Step 392 determines if the bar code is to be suppressed. If yes, step 394 sets bar code suppress and control passes to point 15, which is continued in FIG. 15. If not, step 396 determines if the characters are to be suppressed. If yes, step 398 sets characters suppress and control passes to step 400. If not, step 400 determines if a bar code orientation has been entered. If yes, step 402 sets the selected orientation. If not, step 404 sets a default orientation. Step 406 then determines if the bar code is to be rotated. If so, step 408 sets rotate bar code. In response to a determination of no by step 406 or a completion of step 408, control from steps 406 and 408 passes to point 15, which continues in FIG. 15.

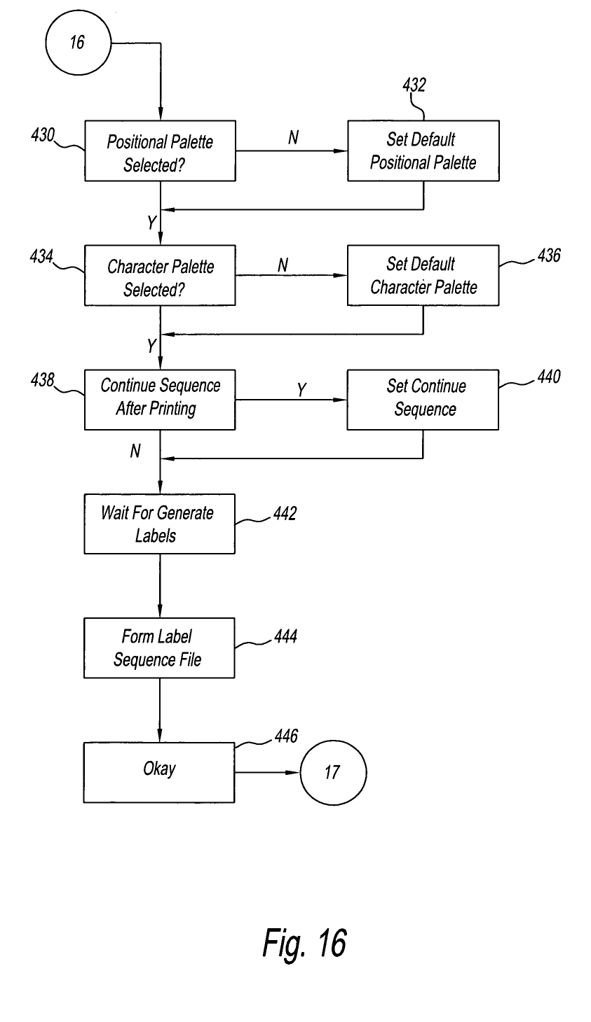

Referring to FIG. 15, point 15 continues to step 412 that determines if a check character has been entered. If yes, step 414 sets the selected check character and control passes to step 416. If step 412 determines that no check character has been entered, step 416 determines if increment is set. If yes, step 418 records increment set. If not, step 420 records decrement set. Step 422 records the amount of increment or decrement. Step 424 records the total label length. Step 426 determines if pad characters have been entered and, if yes, step 428 records the pad characters. In response to a determination of no by step 426 or a completion of step 428, control passes from steps 426 and 428 to a point 16 that is continued in FIG. 16.

Referring to FIG. 16, point 16 continues to step 430 that determines if a positional palette has been selected and, if not, step 432 sets a default positional palette. Step 434 responds to a Yes determination of step 430 or to a completion of step 432 to determine if a character palette has been selected and, if not, step 436 sets a default character palette. Step 438 responds to a yes determination of step 434 or to a completion of step 436 to determine if the ordered sequence is to be continued after printing. If so, step 440 records or sets continue the sequence. Step 442 responds to a No determination of step 438 or a completion of step 440 by waiting for actuation of generate labels button 188 (FIG. 8). When generate labels button 188 has been actuated, step 444 forms a labels sequence file. Step 446 waits for actuation of OK button 190 (FIG. 8). When OK button 190 has been actuated, control passes to a point 17 that is continued in FIG. 17.

Referring to FIG. 17, point 17 continues at step 450 that presents print screen 200 of FIG. 10. Step 452 determines if all labels are selected. If not, step 454 determines if selected label area 210 is selected. If not, step 452 is repeated. If yes, step 456 presents a label selection box and records the labels by the user and control passes to step 458. If step 452 determines that all labels are selected, control passes to step 458. Step 458 determines if a print starting point has been entered. If yes, step 460 records the entered start point. If not, step 462 sets a default start point. Step 464 determines if printing is serial by row and, if yes records serial by row. If not, step 466 records serial by column. After a no determination by step 464 or completion of step 466, step 468 waits for actuation of OK button 216 and, when actuated, begins a print operation to print the labels of the label job.

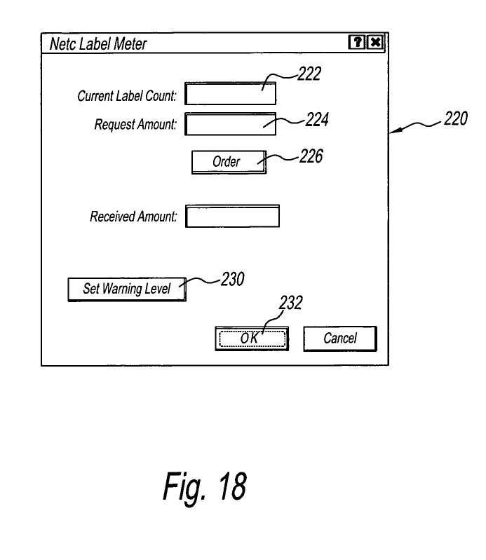

Referring to FIG. 18, a label meter screen 220 has a current label count area 222 in which is presented the current count or number of labels in the user's label inventory. A request amount area 224 is for user entry of a refill order amount. An order button 226, when actuated by the user, will start an order process with a label vendor, for example, vendor computer 36 of FIG. 1. A received amount area 228 is for user entry of a refill quantity of labels that have been received. A set warning level button 230, when actuated will present a dialog box (not shown) for setting or adjusting a warning count that represents a low inventory level. Actuation of an OK button 232 will enter the refill quantity and any changes to the warning count into label meter program 500.

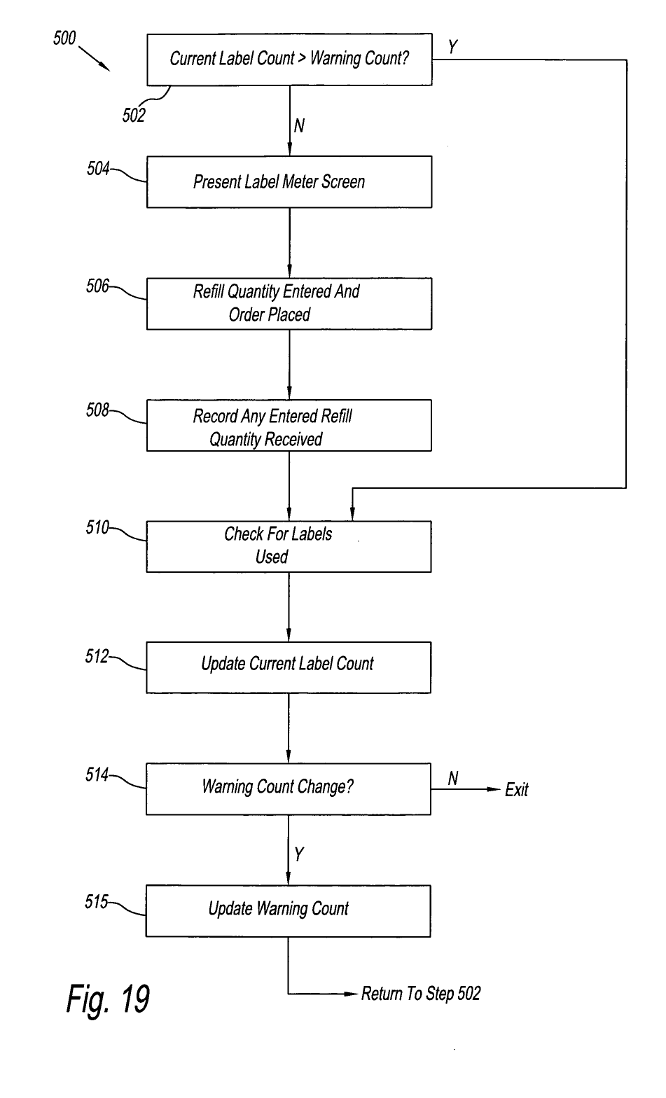

Referring to FIG. 19, label meter program 500 begins at step 502 that determines if the current label count is greater than the warning count. If yes, control passes to step 510. If no, step 504 presents label meter screen 502. Step 506 records any refill order entered and placed by actuation of order button 226. Step 508 records any entry of a refill quantity that has been received. Step 510 checks if any labels have been used by any job since the last time program 500 has run. Step 512 updates the current label count with any refill labels received and any labels used. Step 514 determines if a warning count change has been entered. If yes, step 516 updates the warning count and step 502 is repeated. If step 514 determines that there has been no change to the warning count, program 500 is exited.

Program 500 is run periodically either as a part of label program 300 or separately therefrom. In either event, if the number of labels of a job being created, exceeds the current label count, execution of the job will be prevented. The label meter program is advantageous as it serves as a reminder for the user to order refill labels and prevents execution of current jobs if the user's label inventory is inadequate for the job.

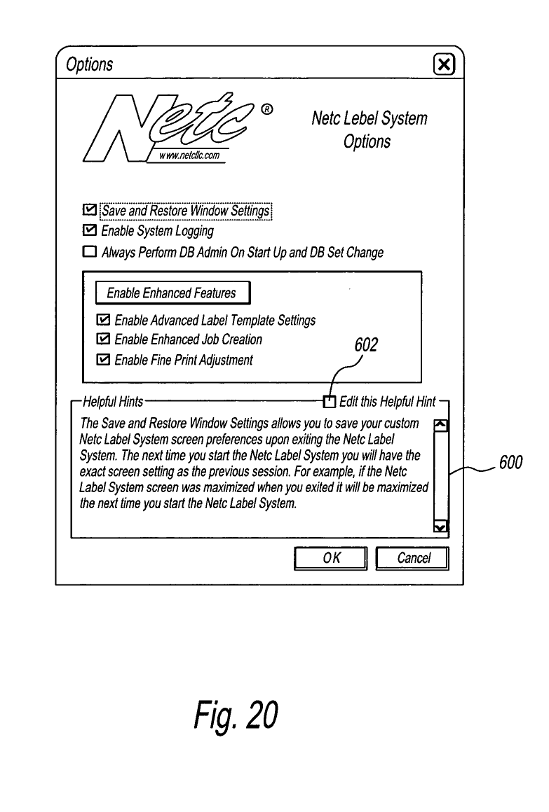

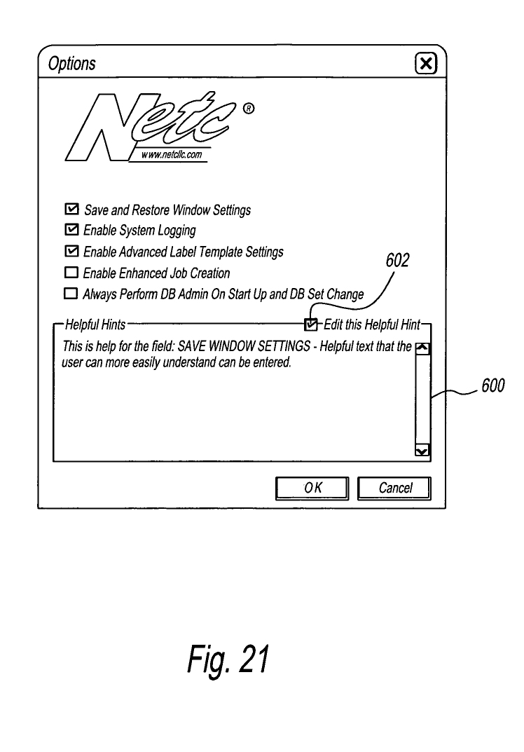

Referring to FIGS. 20 and 21, one or more display screens of the user interactive dialogs or sessions may contain a helpful hint area 600. This is a user editable field level help system. The helpful hints are an added feature to the application that provides field level help that an end user can modify if the help text supplied by the provider is not sufficient. By clicking the user selectable option 602 for Edit the Helpful Hint, the user is enabled to edit the helpful hint in helpful hints area 600. The original text is presented so that it can now be added to, modified and/or deleted to provide a user designed helpful hints. Thereafter, the edited helpful hint will be presented to the user on the display screen that was edited.

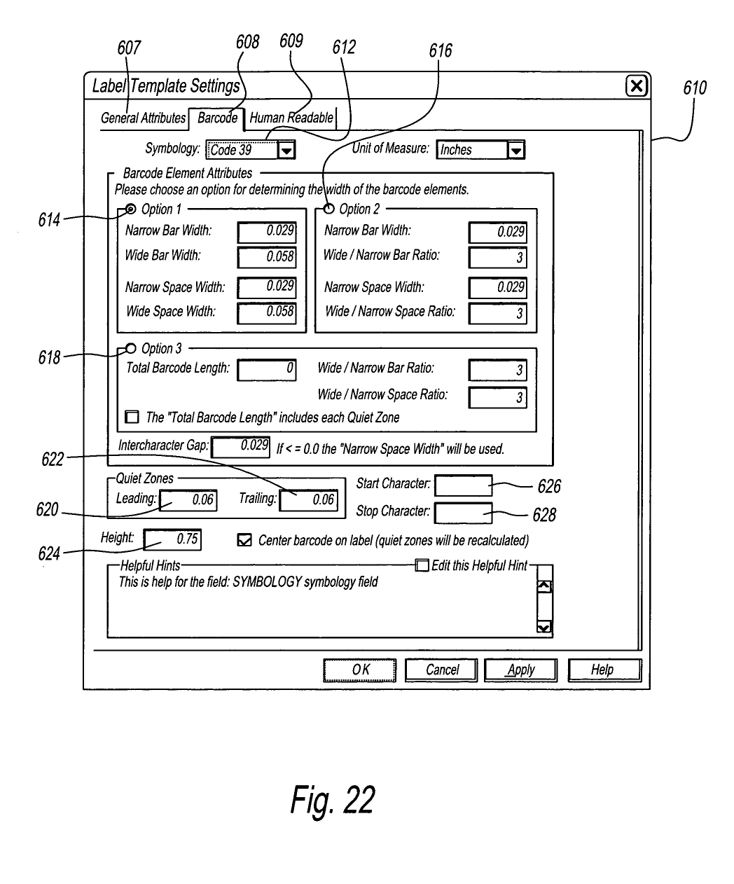

Referring to FIG. 22, a display screen 610 includes three selection tabs, a bar code tab 607, a human readable tab 608 and a general attributes tab 609. Bar code tab 607, which is selected in FIG. 22, permits label template barcode attributes to be specified for creating a new bar code or editing an existing bar code. The created or edited bar code can be used by a barcode rendering engine that may be included in label program 300 (FIG. 2) for printing the barcode portion of the label. All barcodes are generated by an internal barcode rendering engine and not by fonts. This enables the creation of precision (customized) barcodes.

The fields found in this dialog are needed to configure the barcode attributes. A user selectable option 612 permits the user to select a particular bar code symbology, which in the example shown in FIG. 22 is bar code 39. Based on the bar code symbology selection, the user is presented with user selectable options, which for symbology 239 are three user selectable options 612, 614 and 616. The option the user chooses depends on the available information concerning the barcode. If the available information is bar and/or space width in a unit of measure, the user may select option 614 to specify narrow and wide bar widths and narrow and wide space widths, where narrow means narrowest and wide widest. If the available information is narrow bar width and wide/narrow bar ratio and/or narrow space width and wide/narrow space ratio, the user may select option 616 to specify these known values. If the user selects option 618, the user may enter total bar code length, wide/narrow bar ratio and wide/narrow space ratio. User selectable options 620 and 622 permit the user to specify leading and trailing quiet zones. A user selectable option 624 permits the user to specify the height of the bar code. User selectable options 626 and 628 permit the user to specify to specify the start and stop characters of an ordered series of labels.

Dependent on the selection in the symbology box, a different combination of fields can be presented, some of which may be the same and others of which may be different.

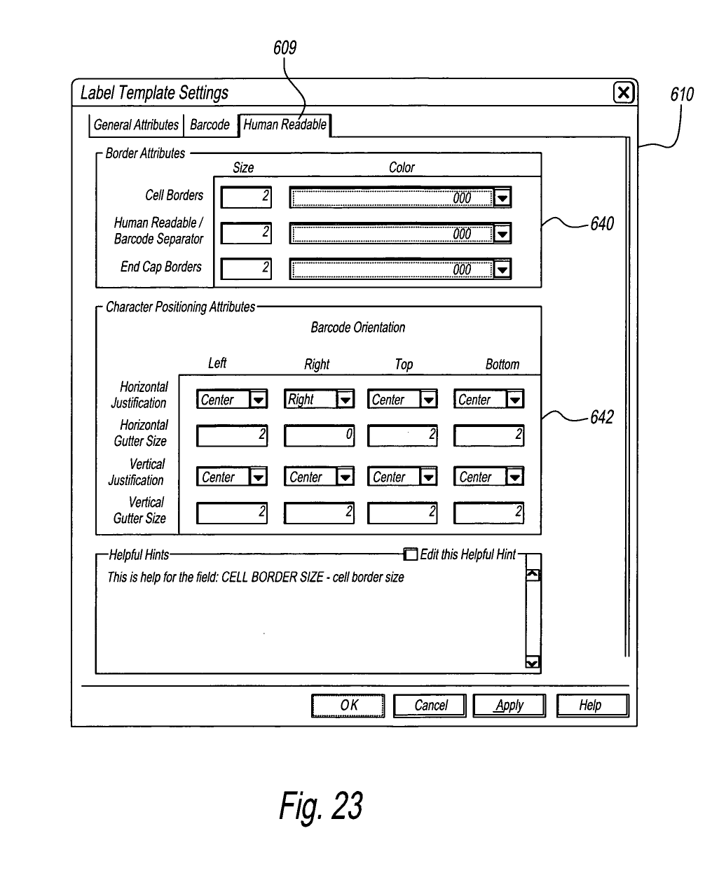

Referring to FIG. 23, display screen 610 is shown with human readable tab 609 selected. This enables the user to select one or more user selectable options to specify within label templates one or more human readable attributes that will be used by a human readable rendering engine upon creation of the human readable portion of the label by the user. The human readable rendering engine may be included in label program 300 of FIG. 2. These human readable attributes allow the user greater flexibility to position characters within cells of a label as well as configure the size and color of borders. To this end, the user can use a user selectable option 640 to input border attributes, for example, size of cell border, human readable/barcode separator and end cap borders as well as a color for each. The user can also use a user selectable option 642 to input character positioning attributes to justify horizontally and vertically the position of the human readable characters within the character positions or cells and to specify the horizontal and vertical gutter sizes.

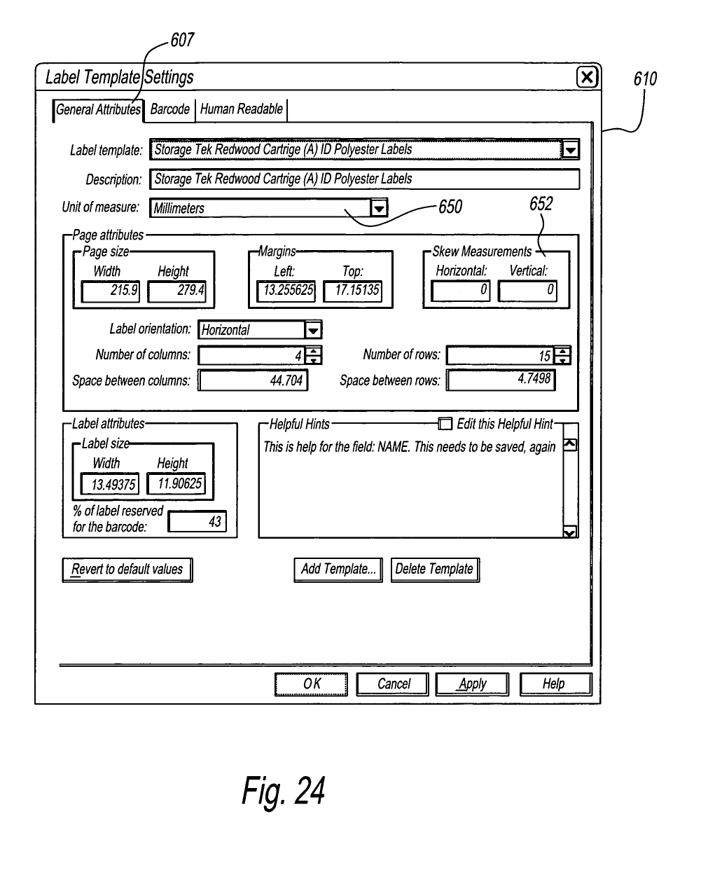

Referring to FIG. 24, other new attributes within the label templates include horizontal and vertical skew measurements. These are used to improve and compensate for printer feeding deficiencies and label stock die cut issues. For example, the user can use a selectable user option 650 to set a unit measure, for example, millimeters. The user can use a skew measurement user selectable option 652 to set a compensation for horizontal skew, vertical skew or both. With the unit of measure set to millimeters and a 1 in the vertical skew measurement box, there will be provided a skew gradient from 0 to one mm. for a column of 20 labels with respect to the left margin. Similar skew control can be user specified for a row of labels using the unit of measure and horizontal skew measurement box.

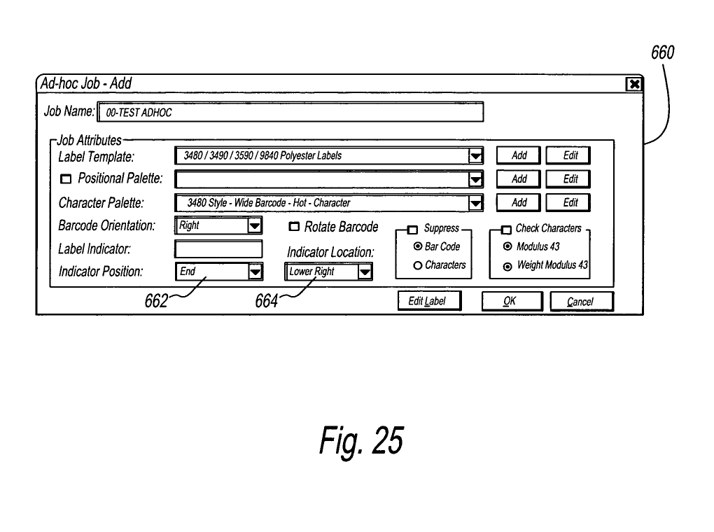

Referring to FIG. 25, an ad-hoc job display screen 660 gives the user the ability to specify within an ad-hoc job a position of the label indicator on the human readable portion of the label as well as within the barcode. Display screen 660 can be used in place of display screen 90 shown in FIG. 6. Display screen 660 includes a user selectable option 662 that allows the user to specify a location for an indicator within the bar code at the beginning or the end thereof. In alternate embodiments, the user can be allowed to select any character position along the bar code length for placement of the indicator.

Display screen 660 includes a user selectable option 664 to specify a location of an indicator within the human readable character cells portion of the label. Using this option, the user can select a corner of either of the endmost cells. For example, if the cells are arranged vertically, the location can be specified as the lower left or lower right corner of the bottom most cell or as the upper left or upper right corner of the top most cell.

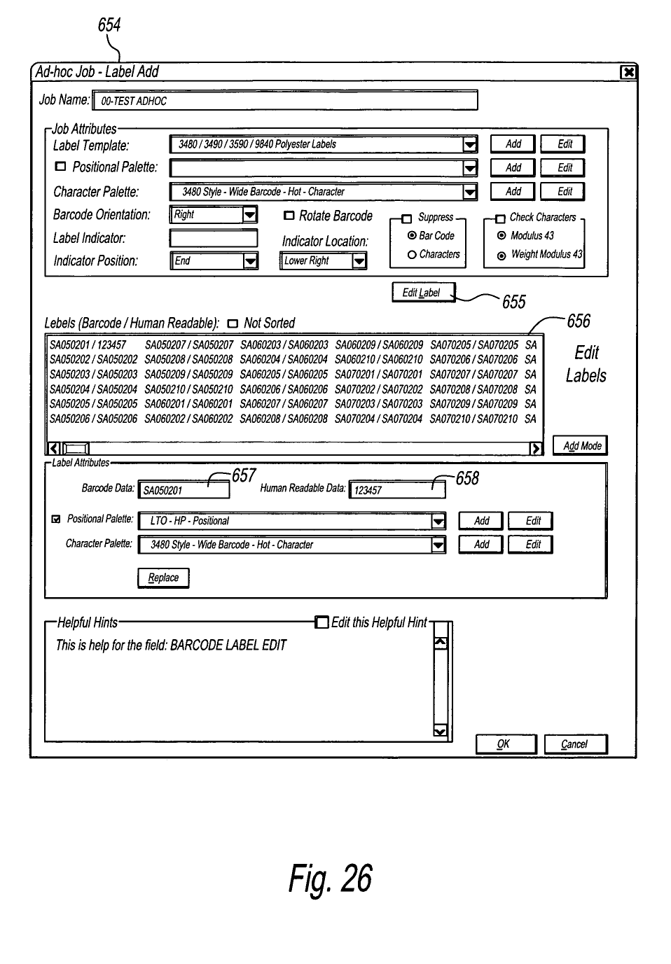

Referring to FIG. 26, an ad-hoc label add screen includes an edit labels user selectable option 655. When user selectable option 655 is selected, editing of the labels is enabled. When the user selects a label in a box 656 as by clicking with a mouse, the selected label is presented in user selectable options 657 and 658. User selectable option 685 allows editing of the bar code representation of the selected label and user selectable option 658 allows editing of the human readable counterpart representation of the selected label. This permits the bar code and counterpart human readable code to have the same representation or different representations. For example, bar code data can be specified as “123456” and human readable data can be specified as “03-04 123456”. The human readable data now indicates a date along with the barcode data and the bar code data contains only the necessary information needed without the date.

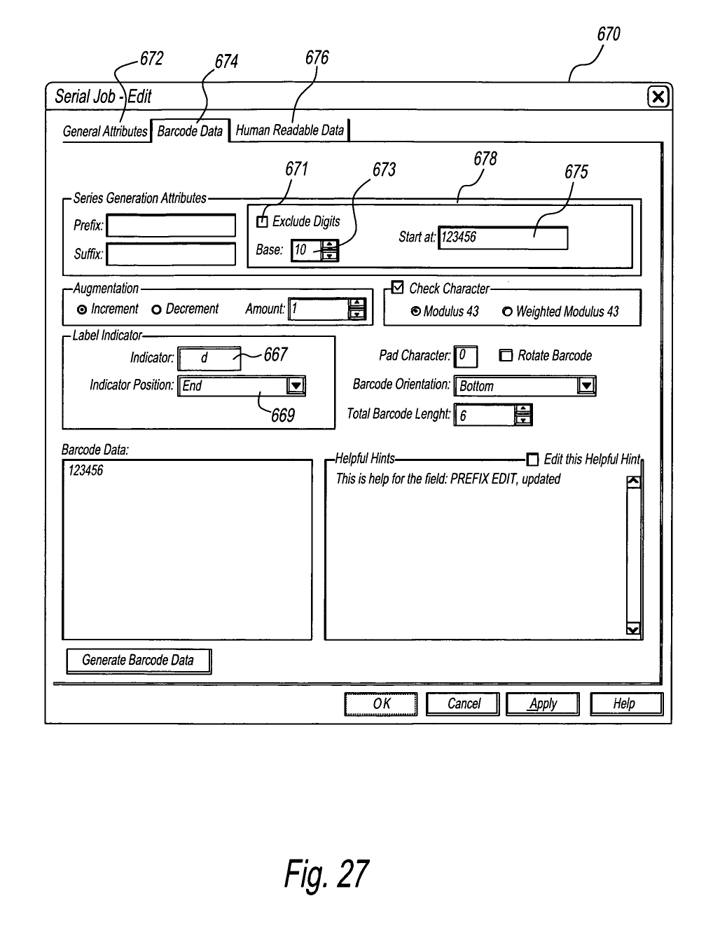

Referring to FIG. 27, a display screen 670 has user selectable tabs 672, 674 and 676 for selection of general attributes, bar code attributes and human readable attributes for use within a serial job. With bar code tab 674 selected, the user is presented an area 678 with several user selectable options regarding the bar code. By operating a user selection option 673, the user can specify a base for an alphanumeric series. By operating a user selection option 671, the user can specify that numeric digits be excluded from the series, thereby creating an all-alphabetic series. By operating a user selection option 675, the user can specify a starting value for the series.

Thus, the user can specify that the value of the barcode portion of each label series is to be generated with a numerical base ranging from 2 to 36 and digits can be either included or excluded. Instead of being limited to creating a series of labels where only the numeric digits 0-9 can be incremented (base 10), it is possible to specify a greater base and include alphabetical characters as well. For example, consider the following series: 000000 to 999999, 99999A, 99999B, 99999C, and so on. As another example, consider a base 36 series 000000 to 000009, 00000A to 00000Z, 000010 to 000019, 00001A to 00001Z, and so on. When digits are excluded, no numeric values 0-9 will be included as part of the mathematical sequence, i.e., the sequence is alphabetic only.

The user by operation of a user selectable option 667 can specify a value of an indicator, for example, the symbol “d”. In alternate embodiments of the invention, the indicator may have more than one character. By operation of a user selectable option 669 the user can specify the location of the indicator within the bar code, for example, at the start, end or at the start and end.

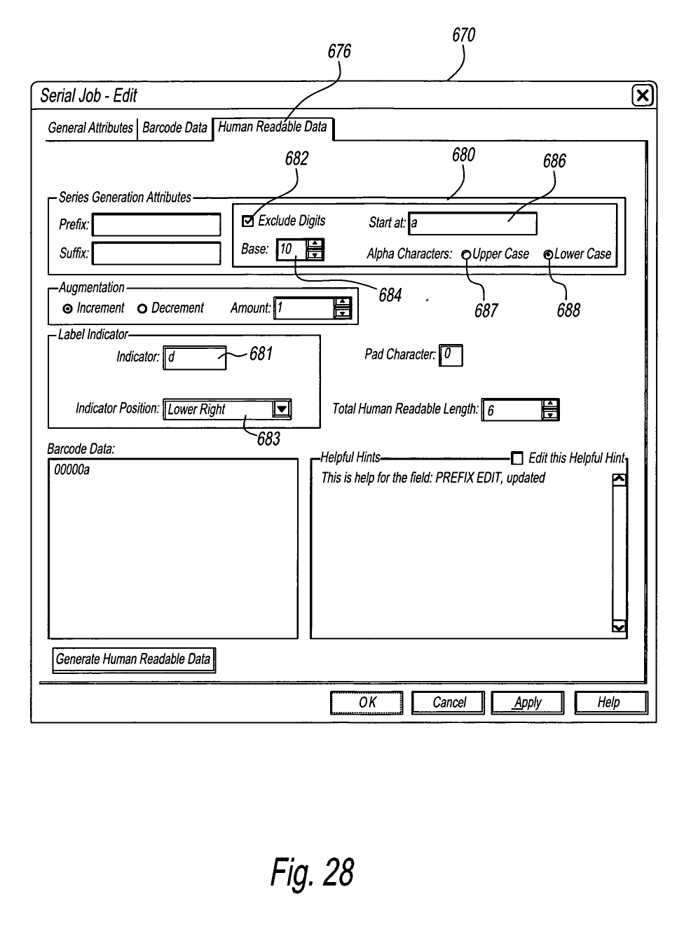

Referring to FIG. 28, with the human readable tab 676 of display screen 670 selected, the user is presented in an area 680 with several user selectable options. By operating a user selection option 684, the user can specify a base for an alphanumeric series. By operating a user selection option 682, the user can specify that numeric digits be excluded from the series, thereby creating an all-alphabetic series. By operating a user selection option 686, the user can specify a starting value for the series. By operating a user selection option 687 or 688, the user can specify upper or lower case for the alphabetic characters.

In the example shown in FIG. 28, numeric digits are excluded and the base is selected as 10. This creates an all alphabetic series that is selected as lower case and selected to begin at a value of a. Since the selected base is 10, only the alphabetic characters a through j are used. For a character cell length of 6, the start value is “aaaaaa” and the end value is “jjjjjj”.

Being able to specify a larger base and having the ability to exclude digits provides the following flexibility:

1) A “Base” of 36 provides up to 2,176,782,336 unique labels having a length of six character cells. This is the maximum amount of labels for a six character label. In contrast, a base of 10 provides up to 1,000,000 unique labels for a six character label.

2) Excluding digits user selectable option 682 provides for a series of labels containing only letters with a base with a high value of 26. The base can only have a value in the range of 2 to 26 because the 10 digits are being excluded. A base of 26 provides for 308,915,776 unique labels while ensuring that there are no duplicate labels introduced.

The user by operation of a user selectable option 681 can specify a value of an indicator, for example, the symbol “d”. By operation of a user selectable option 683 the user can specify the location of the indicator within the total cell area of the human readable character cells. Using this option, the user can select a corner of either of the endmost cells. For example, if the cells are arranged vertically, the location can be specified as the lower left or lower right corner of the bottom most cell or as the upper left or upper right corner of the top most cell. for example, at the start, end or at the start and end.

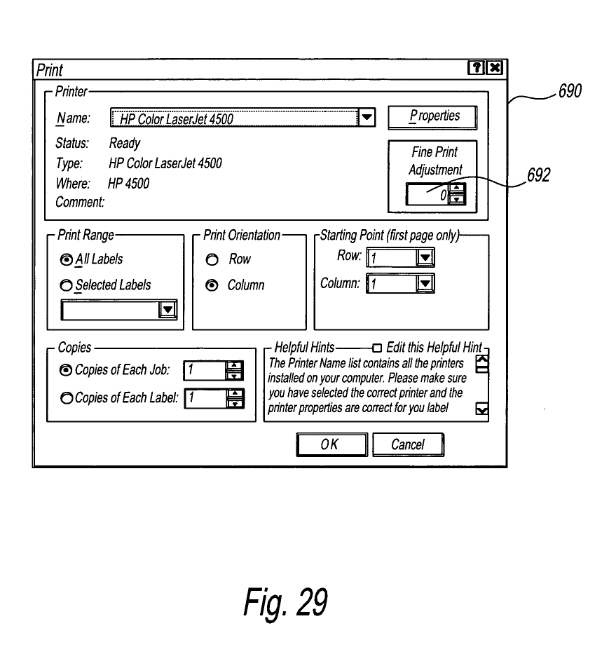

Referring to FIG. 29, a display screen 690 includes a user selectable option 692 that the user can use to specify a fine print adjustment to adjust the bar code line width and spacing by specifying a positive or negative integer value. A positive integer value decreases the bar width while increasing the space width rendered by the printer by the value ×0.001 inches while keeping the overall barcode length the same. A negative value increases the bar width while decreasing the space width rendered by the printer by the value ×0.001 inches while keeping the overall barcode length the same. This value can vary among printers of different manufacturers as well as among models of the same manufacturer.

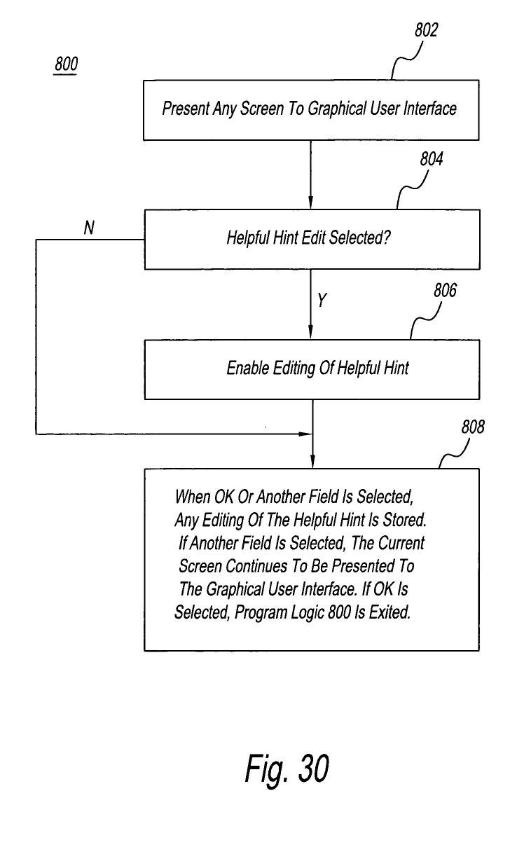

Referring to FIGS. 20, 21 and 30, label program 300 includes a program logic 800 for the helpful hint editing feature that can be used with any screen that is presented to graphical user interface 41. Label program logic 800 begins at step 802 with a presentation of a screen containing a helpful hint to graphical user interface 41. At step 804 it is determined if helpful hint user selectable option 602 is selected. If yes, at step 806 editing of the helpful hint is enabled. If helpful hint user selectable option 602 is not selected at step 804, control passes to step 808. Step 808 responds to the selection of either of the user selectable option OK or another field of the current display screen to store any editing of the helpful hint. If another field is selected, the current screen continues to be presented to graphical user interface 41. If OK is selected, program logic 800 is exited.

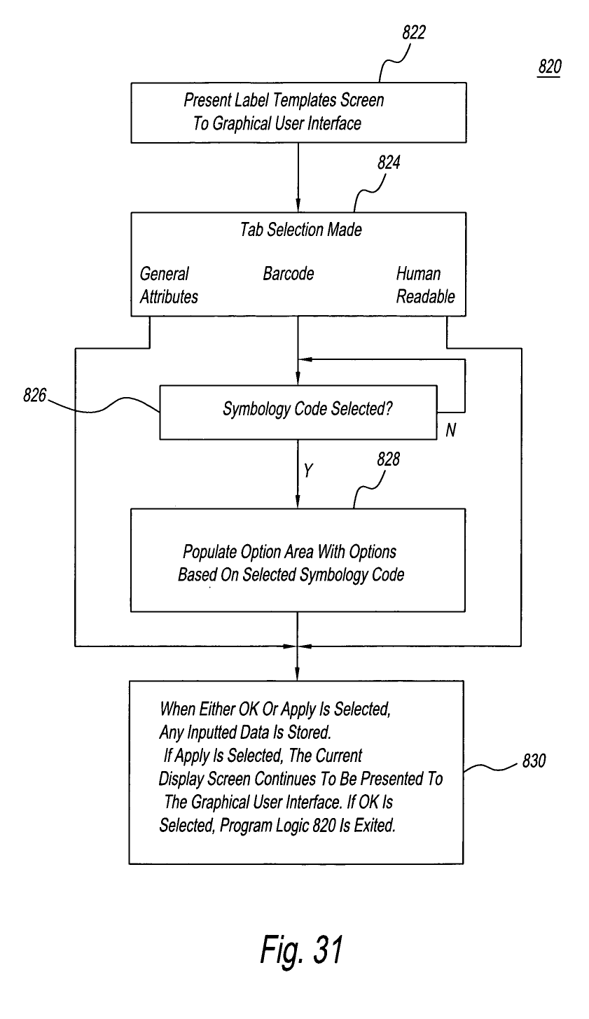

Referring to FIGS. 22, 23, 24 and 31, label program 300 includes a program logic 820 for the label template settings screen 610 that is presented to graphical user interface 41. Program logic 820 begins at step 822 with a presentation of screen 610 to graphical user interface 41. At step 824, it is determined that a tab selection has been made. If the bar code tab is selected, at step 826 it is determined if a symbology code has been selected. If not, step 826 is repeated until a symbology code is selected or inputted. If yes, step 828 then populates the option area with options based on the selected symbology code. At step 830, there is a wait until the user has inputted bar code data. Step 830 responds to the selection of either of the user selectable options OK or Apply (FIG. 22, 23 or 24) to store any inputted data. If Apply is selected, the current screen continues to be presented to graphical user interface 41. If OK is selected, program logic 820 is exited.

If at step 824, either the general attributes tab 607 or the human readable tab 609 is selected, step 830 is performed next. Again, there is a wait until the user has inputted any data. Step 830 responds to the selection of either of the user selectable options OK or Apply (FIG. 22, 23 or 24) to store any inputted data. If Apply is selected, the current screen continues to be presented to graphical user interface 41. If OK is selected, program logic 820 is exited.

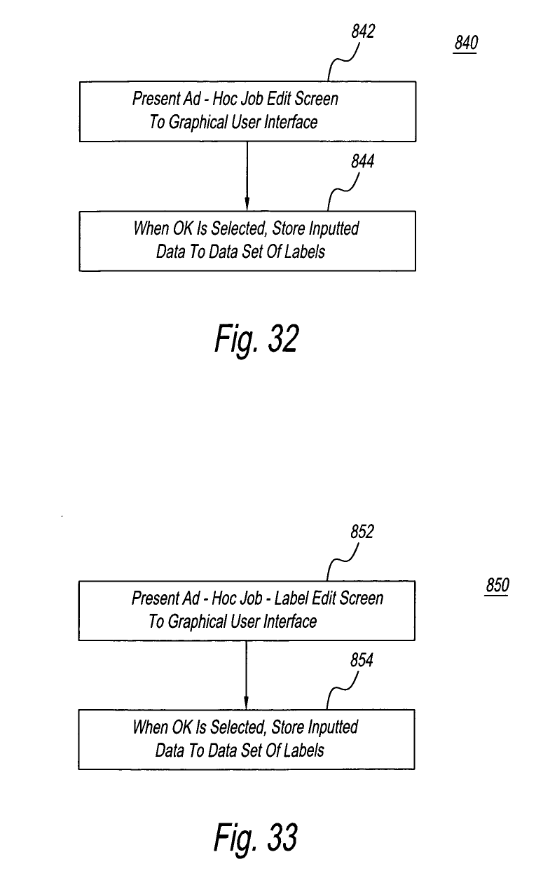

Referring to FIGS. 25 and 32, label program 300 includes a program logic 840 for the ad-hoc edit screen 660 that is presented to graphical user interface 41. Program logic 840 begins at step 842 with a presentation of screen 610 to graphical user interface 41. At step 844, there is a wait until the user has inputted bar code and indicator data. When the OK user selectable option is selected, step 844 causes any inputted data to be stored to the data set of the labels.

Referring to FIGS. 26 and 33, label program 300 includes a program logic 850 for the ad-hoc label add screen 654 that is presented to graphical user interface 41. Program logic 850 begins at step 852 with a presentation of screen 654 to graphical user interface 41. At step 854, there is a wait until the user has inputted bar code and indicator data. When the OK user selectable option is selected, step 854 causes any inputted data to be stored to the data set of the labels.

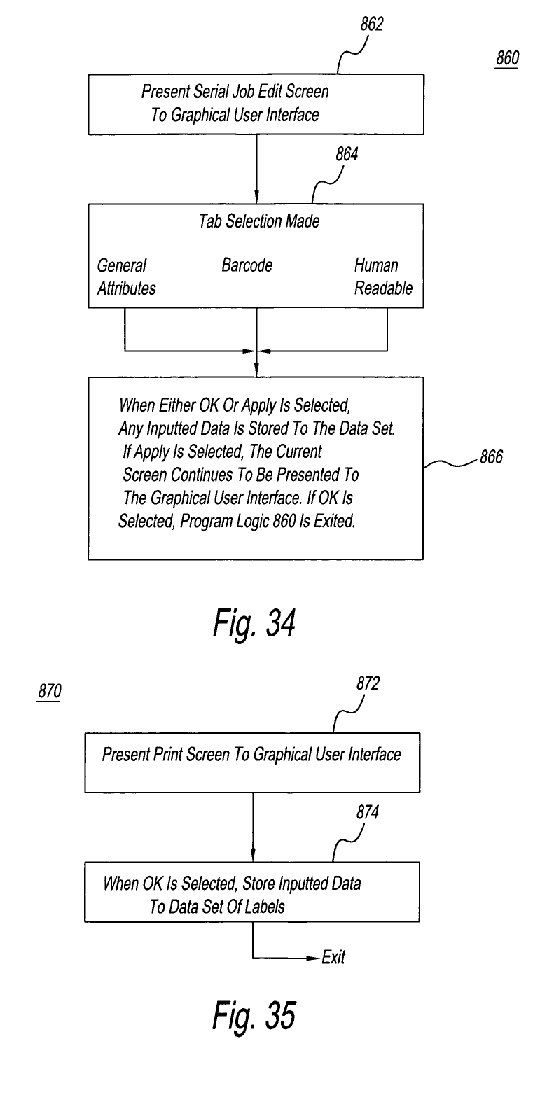

Referring to FIGS. 27, 28 and 34, label program 300 includes a program logic 860 for the serial job edit screen 670 that is presented to graphical user interface 41. Program logic 860 begins at step 852 with a presentation of screen 670 to graphical user interface 41. At step 864, it is determined that a tab selection has been made. Step 864 is performed next in the case of the selection of any of the general attributes tab 672, the bar code tab 674 and the human readable tab 676. Step 866 waits until the user has inputted bar code or human readable series or sequence data and indicator data. Step 866 responds to the selection of either of the user selectable options OK or Apply (FIG. 27 or 28) to store any inputted data. If Apply is selected, the current screen continues to be presented to graphical user interface 41. If OK is selected, program logic 860 is exited.

Referring to FIGS. 29 and 35, label program 300 includes a program logic 870 for the print screen 690 that is presented to graphical user interface 41. Program logic 870 begins at step 872 with a presentation of screen 690 to graphical user interface 41. At step 874, there is a wait until the user has inputted the print data (including fine print adjustment data). When the OK user selectable option is selected, step 874 causes any inputted data to be stored to the data set of the labels.

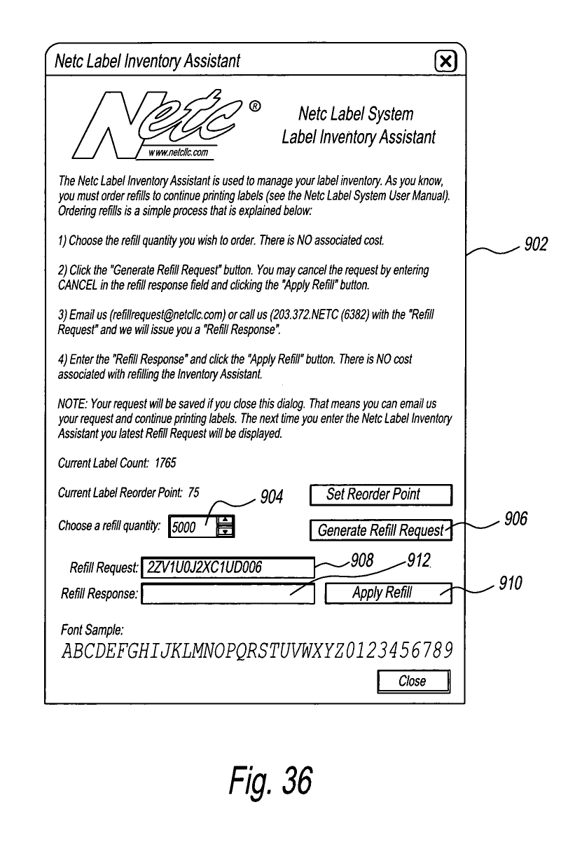

Label inventory assistant program 900 will be described with reference to FIG. 36. Label Inventory Assistant has two major purposes, namely, it provides the end-user with a warning the end user's inventory of a particular label stock(s) is low and it helps the label vendor to determine if an end-user is using its label stock. The latter, e.g., can affect the technical support offered to them by vendor. The vendor will know if the end-user is not using the vendor's label stock because the end user will need a refill at some point and the vendor will have no record of a label stock purchase.

When the end user purchases the label design system, label inventory assistant program 900 will have a default current label count. This default count, e.g., can be a number of labels furnished with the system and a default label reorder point. As the system prints a label, the current label count is decremented. When the current label count reaches the current label reorder point, the system will warn the end user that there is a need to purchase more labels. The system will not print any more labels when the current label count reaches 0. The end user then places a purchase order for 30,000 labels of type A, which, for example, come in sheets of 30 labels per sheet and 20,000 labels of type B, which, for example come in sheets of 20 labels per sheet.

FIG. 36 shows a display screen 902 that is presented by label inventory assistant program 900 to the end user via graphical user interface 41. When the end-user receives the label stock ordered by the purchase order, the end user issues a refill request by invoking a dialog with display screen 902. Display screen 902 includes a user selectable option 904 for the end user to enter a quantity of labels for a refill order, for this example the quantity is 50,000. Then, the end user can optionally select a generate the refill request user selectable option 906 to confirm the quantity. Label inventory assistant program 900 automatically generates a refill request that is automatically entered in a refill box 908. This refill request, for example can be an encrypted number that includes the following information:
a. The end-user specified label quantity.
b. The serial number of the system that was used to create the refill request (i.e., the serial number is stored at the time of manufacture or installation and is known to label inventory assistant program 900).
c. The version of the system that was used to create the refill request (i.e., the version is stored at the time of manufacture or installation and is known to label inventory assistant program 900).
d. The current label count as known by the software. This is the current label count that is adjusted as each label is printed.
e. A character that is used to encrypted the refill response.

The end-user now communicates the refill request with the vendor either by email, phone, fax, etc.

The vendor then decodes the refill request. For example, a separate utility application can be used. If the end-user needs to upgrade to the most current version of the software the vendor will know that. If the end user has installed a new copy of the software, the vendor will know that by the serial number that is decoded. If the end user's current label count is questionable, the vendor will know that as well.

The vendor now specifies, by label stock type, label refill quantities for each type of label stock the end-user just purchased and generates a refill response, which is communicated to the end user by email, phone, fax, etc. The refill response contains an entry for every type of label stock that the vendor is assigning a quantity. These will be four positions each. Each entry will contain a label sheet identity and a number of label sheets. This information will be encrypted using the encryption character delivered in the refill request

The end-user inputs this refill response into a refill response field 912 of display screen 902 and then clicks an Apply Refill user selectable option 910. Label inventory assistant program 900 checks the refill response against the refill request and if there is a match, then the refill response is decoded, the proper number of labels are applied to each label type's inventory and the current label count is updated. The end-user only needs to specify a total number of labels desired in the refill request and does not need to specify a number of labels for each type. When labels are thereafter printed, label inventory assistant program 900 decrements the current label count by one for each label printed and deducts from the inventory the proper number of labels based on the label type.

Label inventory assistant program 900 allows the vendor to track and warn end-users when they get low on a specific type of label sheet. Label inventory assistant program 900 is useful to track inventory of a plurality of types of label stock that have both the same number of labels on a sheet and also have the same exact label layout (just different part numbers). The label sheet identity allows the vendor to differentiate between any and all types of label stock.

The present invention having been thus described with particular reference to the preferred forms thereof, it will be obvious that various changes and modifications may be made therein without departing from the spirit and scope of the present invention as defined in the appended claims.

1. A label making apparatus for forming a data set for a series of labels comprising:
a computer configured for interactive sessions with a graphical user interface; and
wherein said computer comprises a label program that forms said data set during one or more of said interactive sessions, wherein said label program provides to said graphical user interface a user interactive label design display screen that comprises a standard helpful hint and a user selectable option to edit said standard helpful hint to form a user customized helpful hint, and wherein said label program provides said customized helpful hint for subsequent presentations of said label design display screen to said graphical user interface.

2. The label making apparatus of claim 1, wherein said graphical user interface comprises a display and one or more input devices, wherein said label design display screen is presented on said display, and wherein said user uses said one or more input devices to select said user selectable option and to edit said standard helpful hint.

3. The label making apparatus of claim 1, further comprising a printer, and wherein said label program uses said data set to control said printer to print said series of labels on label stock.

4. A label making apparatus for forming a data set for a series of labels that have an ordered sequence of values, each label including a machine readable code and a human readable character set, said apparatus comprising:
a computer configured for interactive sessions with a graphical user interface; and
wherein said computer comprises a label program that forms said data set during one or more of said interactive sessions, wherein said label program provides to said graphical user interface one or more user interactive label design display screens that comprise user selectable options to select attributes for said bar code and for said human readable character set, wherein said attributes comprise alphabetic and/or alphanumeric values, and wherein said label program incorporates attributes selected by said user into said data set so that said ordered sequence has alphabetic and/or alphanumeric values.

5. The label making apparatus of claim 4, wherein said bar code attributes comprise one or more of the bar code attributes selected from the group consisting of: bar code length, bar width, wide bar ratio, inter-character space width, wide space ratio, bar code orientation, numeric value, alphanumeric value, alphabetic value and base for said values.

6. The label making apparatus of claim 4, wherein said label program uses said data set to print said series of labels on a label stock.

7. The label making apparatus of claim 4, wherein said label program responds to a user selection of at least one of said user selectable options to generate bar code values of a bar code and associated human readable values for the series of labels.

8. The label making apparatus of claim 7, wherein at least one of said bar code values and an associated one of said human readable values differ from one another.

9. The label making apparatus of claim 4, wherein said ordered sequence of at least one of said bar codes and human readable character sets is selected from the group consisting of: numeric, alphanumeric and alphabetic.

10. The label making apparatus of claim 4, wherein said label program responds to a user selection of at least one of said user selectable options to establish a base in the range of 2 through 36 for said ordered sequence.

11. The label making apparatus of claim 4, wherein said label program responds to a user selection of at least one of said user selectable options to establish a base in the range of 11 through 36 for said ordered sequence.

12. The label making apparatus of claim 12, wherein said label program responds to a user selection of at least one of said user selectable options to exclude numeric values from said ordered sequence.

13. The label making apparatus of claim 4, wherein said label program responds to a user selection of at least one of said user selectable options that inputs a bar code type to present to the user a set of user selectable bar code attributes based on said bar code type.

14. The label making apparatus of claim 4, wherein said label program responds to a user selection of at least one of said user selectable options, which regards printing said series of labels on label stock, to select a skew adjustment or a fine print adjustment.

15. The label making apparatus of claim 4, wherein said label program responds to a user selection of at least one of said user selectable options to select character justification in a character cell.

16. The label making apparatus of claim 4, wherein said graphical user interface comprises a display and one or more input devices, wherein said label design display screen is presented on said display, and wherein said user uses said one or more input devices to select said user selectable option and to select said user selectable options.

17. The label making apparatus of claim 4, wherein at least one of said label design display screens provides to said graphical user interface one or more user selectable options to position a label indicator within a cell of either the bar code or the human readable character set of at least one label of said series of labels.

18. The label making apparatus of claim 17, wherein said label indicator is positionable in a corner of at least one of the cells of the human readable character set.

19. The label making apparatus of claim 19, wherein said label indicator is positionable within at least one end cell of said bar code.

20. A method that uses a computer and a graphical user interface in interactive sessions for forming a data set for a series of labels comprising:
using said computer to provide to said graphical user interface during one or more of said user interactive sessions, a user interactive label design display screen that comprises a standard helpful hint and a user selectable option to edit said standard helpful hint;
responding to said user editing said standard helpful hint to form a user customized helpful hint; and
thereafter providing said customized helpful hint for subsequent presentations of said label design display screen to said graphical user interface.

21. A method that uses a computer and a graphical user interface in interactive sessions for forming a data set for a series of labels that have an ordered sequence of values, each label including a machine readable code and a human readable character set, said method comprising:
using said computer to provide to said graphical user interface during one or more of said user interactive sessions, at least one user interactive label design display screen that comprise user selectable options to select attributes for said bar code and for said human readable character set, wherein said attributes comprise alphabetic and/or alphanumeric values, and wherein said label program incorporates attributes selected by said user into said data set so that said ordered sequence has alphabetic and/or alphanumeric values.

22. A computer media comprising executable instructions of a label program for controlling a computer and a graphical user interface via interactive sessions to form a data set for a series of labels, wherein said executable instructions cause said computer:
(a) to provide to said graphical user interface during one or more of said user interactive sessions, a user interactive label design display screen that comprises a standard helpful hint and a user selectable option to edit said standard helpful hint,
(b) to respond to said user editing said standard helpful hint to form a user customized helpful hint, and
(c) to thereafter providing said customized helpful hint for subsequent presentations of said label design display screen to said graphical user interface.

23. A computer media comprising executable instructions of a label program for controlling a computer and a graphical user interface via interactive sessions to form a data set for a series of labels that have an ordered sequence of values, each label including a machine readable code and a human readable character set, wherein said executable instructions cause said computer:
(a) to provide to said graphical user interface during one or more of said user interactive sessions, at least one user interactive label design display screen that comprises user selectable options to select attributes for said bar code and for said human readable character set, wherein said attributes comprise alphabetic and/or alphanumeric values, and
(b) to incorporate attributes selected by said user into said data set so that said ordered sequence has alphabetic and/or alphanumeric values.

24. A label making apparatus for forming a data set for a series of labels comprising:
a computer configured for interactive sessions with a graphical user interface; and
wherein said computer comprises a label program that forms said data set during one or more of said interactive sessions, wherein said label program provides to said graphical user interface a user interactive label inventory assistant display screen that comprises a current label count, and a user selectable option for entry of a refill quantity for communication to a vendor and a refill response area for entry of a refill response received from said vendor, wherein said refill response comprises for each type of label stock a label sheet identity and the number of label sheets, and wherein said current label count and an inventory of label sheets by type are automatically updated by said refill request.
